(19) United States
(12) Patent Application Publication
(10) Pub. No.: US 2020/0326203 A1
(43) Pub. Date: Oct. 15, 2020

(54) REAL-WORLD TRAFFIC MODEL

(71) Applicant: QUALCOMM Incorporated, San Diego, CA (US)

(72) Inventors: Benjamin Lund, Escondido, CA (US); Anthony Blow, San Diego, CA (US); Edwin Chongwoo Park, San Diego, CA (US)

(21) Appl. No.: 16/549,643

(22) Filed: Aug. 23, 2019

Related U.S. Application Data
(60) Provisional application No. 62/834,269, filed on Apr. 15, 2019.

(51) Int. Cl. G01C 21/36; G01C 21/34; G08G 1/01; H04B 1/3822; H04W 4/02

(52) U.S. Cl. CPC G01C 21/3694; G01C 21/3492; H04W 4/027; G08G 1/0129; H04B 1/3822; G01C 21/3635

(57) ABSTRACT

Disclosed is a method and apparatus for generating a real-world traffic model. The apparatus obtains a first set of device map information associated with one or more devices that are in proximity with a first device, and obtains a second set of device map information associated with one or more devices that are in proximity with a second device. The apparatus determines whether the first set of device map information and the second set of device map information contain at least one common device and in response to the determination that the first set of device map information and the second set of device map information contain at least one common device, and generates a real-world traffic model of devices based on the first set of device map information and the second set of device map information.

### CROSS-REFERENCE TO RELATED APPLICATIONS

This application claims the benefit of and priority to U.S. Provisional Patent Application No. 62/834,269, entitled “Real-World Traffic Model”, filed on Apr. 15, 2019, which is assigned to the assignee hereof and incorporated by reference in its entirety.

### FIELD

This disclosure relates generally to methods, devices, and computer readable medium for generating, updating, and/or using a real-world traffic model.

### BACKGROUND

Advanced driver assistance autonomous systems (ADAS) may be partially autonomous, fully autonomous or provide assistance to a driver. Current ADAS have cameras and ultrasound sensors, and some include one or more radars. However, these current systems operate independent of other nearby vehicles and each perform redundant operations. If the ADAS systems included wireless communication to share information about each other, it may take a significant amount of time until every device included this functionality.

### SUMMARY

An example of a method for generating a real-world traffic model at a first device. The method comprises obtaining, at the first device, a first set of device map information associated with one or more devices that are in proximity with a first device, and obtaining, at the first device, a second set of device map information associated with one or more devices that are in proximity with a second device. The method determines, at the first device, whether the first set of device map information and the second set of device map information contain at least one common device and in response to the determination that the first set of device map information and the second set of device map information contain at least one common device, and generating, at the first device, a real-world traffic model of devices based on the first set of device map information and the second set of device map information.

An example of a device to generate a real-world traffic model may include one or more memory, one or more transceivers and one or more processors communicatively coupled to the one or more memory and the one or more transceivers, wherein the one or more processors may be configured to obtain a first set of device map information associated with one or more devices that are in proximity with a first device. The one or more processors may be configured to obtain a second set of device map information associated with one or more devices that are in proximity with a second device. The one or more processors may be configured to determine whether the first set of device map information and the second set of device map information contain at least one common device and in response to the determination that the first set of device map information and the second set of device map information contain at least one common device, and generate a real-world traffic model of devices based on the first set of device map information and the second set of device map information.

An example of a device for generating a real-world traffic model. The device comprises means for obtaining a first set of device map information associated with one or more devices that are in proximity with a first device, and means for obtaining a second set of device map information associated with one or more devices that are in proximity with a second device. The device comprises means for determining whether the first set of device map information and the second set of device map information contain at least one common device and in response to the determination that the first set of device map information and the second set of device map information contain at least one common device, and means for generating a real-world traffic model of devices based on the first set of device map information and the second set of device map information.

An example non-transitory computer-readable medium for generating a real-world traffic model includes processor-readable instructions configured to cause one or more processors to obtain a first set of device map information associated with one or more devices that are in proximity with a first device, and obtain a second set of device map information associated with one or more devices that are in proximity with a second device. The non-transitory computer-readable medium configured to cause a processor to determine whether the first set of device map information and the second set of device map information contain at least one common device and in response to the determination that the first set of device map information and the second set of device map information contain at least one common device, and generate a real-world traffic model of devices based on the first set of device map information and the second set of device map information.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 shows an example of a communication environment in which various aspects of the disclosure may be implemented.

FIG. 2 shows an example process diagram illustrating a method of generating and/or updating a real-world traffic model.

FIG. 3 is an example map of devices illustrating identifying common devices.

FIG. 4 is an example map of devices illustrating generating one or more real-world traffic models.

FIG. 5 is an example map of devices illustrating one or more real-world traffic models.

FIG. 6A is an example device map information.

FIG. 6B is an example map of devices illustrating one or more real-world traffic models.

FIG. 7 is an example call flow diagram illustrating a method of generating, updating and/or querying a real-world traffic model.

FIG. 8 is an example process diagram for identifying one or more vehicles.

FIG. 9 is an example process diagram determining position information for a temporally occluded vehicle.

FIG. 10A, B, C and D are example maps of vehicles illustrating temporal occlusion and how position information may be determined for that vehicle.

FIG. 11 is an example process diagram for registering a device that is temporally collocated with the vehicle for use with a real-world traffic model.

FIG. 12 is an example process diagram for utilizing a real-world traffic model in an advanced driver assistance system.

FIG. 13 is an example mobile device and the components within the mobile device in which aspects of the disclosure may be implemented.

FIG. 14 is an example server and the components within the server in which aspects of the disclosure may be implemented.

### DETAILED DESCRIPTION

References throughout this specification to one implementation, an implementation, an embodiment, and/or the like mean that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. However, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

Additionally, figures and descriptions of the figures may indicate roads that may have right side driving and/or structured lane markings; however, these are merely examples and the disclosure is also applicable to left side driving, unstructured roads/lanes, etc.

The term “quasi-periodic” refers to an event that occurs periodically with a frequency that may change from time to time, and/or to an event occurs from time to time with no well-defined frequency.

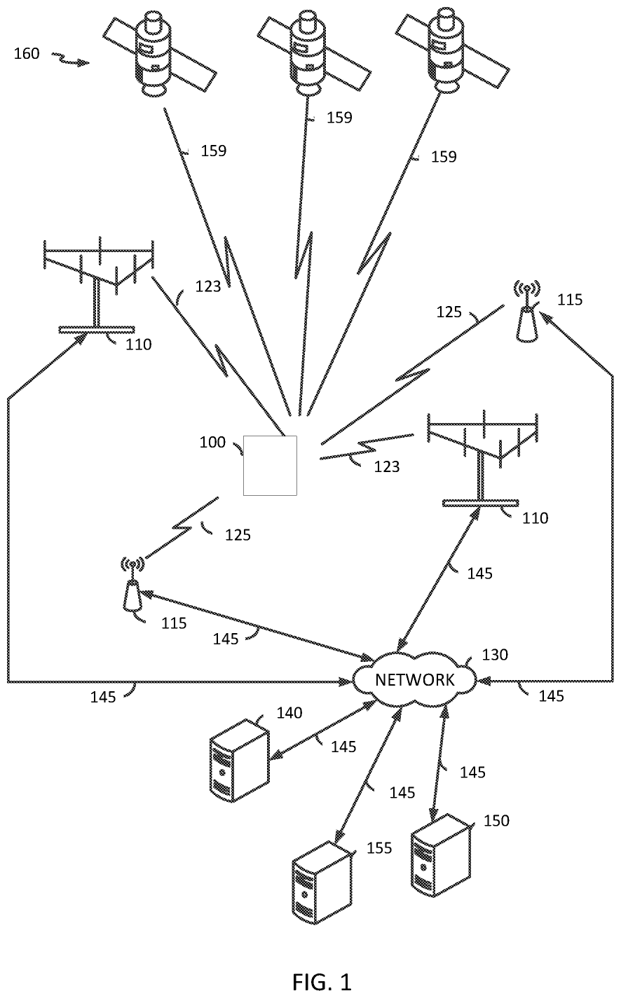

A mobile device (e.g. mobile device 100 in FIG. 1) may be referred to as a device, a wireless device, a mobile terminal, a terminal, a mobile station (MS), a user equipment (UE), a secure user-plane location (SUPL) Enabled Terminal (SET) or by some other name and may correspond to a moveable/portable device or a stationary device. A moveable/portable device may be a cellphone, smartphone, laptop, tablet, PDA, tracking device, transport vehicle, robotic device (e.g. aerial drone, land drone, etc.) or some other portable or moveable device. The transport vehicle may be an automobile, motorcycle, airplane, train, bicycle, truck, rickshaw, etc. The moveable/portable device also be temporarily used in and on behalf of a transport vehicle. For example, a smart phone may be used to communicate on behalf of a transport vehicle while the two are temporally co-located (this may be in conjunction with an on-board device of the transport vehicle but is not required). The mobile device may also be a stationary device, such as a road side unit (RSU), traffic light, etc. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., mobile device 100) may be referred to as a location, location estimate, location fix, fix, position, position estimate or position fix, and may be geographic, thus providing location coordinates for the mobile device (e.g., altitude and longitude) which may or may not include an altitude component (e.g., height above sea level, height above or depth below ground level, floor level or basement level). Alternatively, a location of a mobile device may be expressed as a civic location (e.g., as a postal address or the designation of some point or small area in a building such as a particular room or floor). A location of a mobile device may also be expressed as an area or volume (defined either geographically or in civic form) within which the mobile device is expected to be located with some probability or confidence level (e.g., 67% or 95%). A location of a mobile device may further be a relative location comprising, for example, a distance and direction or relative X, Y (and Z) coordinates defined relative to some origin at a known location which may be defined geographically or in civic terms or by reference to a point, area or volume indicated on a map, floor plan or building plan. In the description contained herein, the use of the term location may comprise any of these variants unless indicated otherwise.

A subject device is an observed or measured device, or a device that is in proximity with an ego device.

An ego device is an observing or measuring information related to its environment, including information corresponding to a nearby subject device. For example, an ego vehicle may obtain image data from its cameras and perform computer vision operations based on this data to determine information, such as position of another device or vehicle (e.g. subject device) relative to the ego device.

Managed (or Infrastructure) communication means point-to-point communication from a client device to a remote base station and/or other network entities, such as vehicle to infrastructure (V2I) but does not include vehicle to vehicle. The remote base station and/or other network entities may be the end destination, or the end destination may be another mobile device that is connected to the same or different remote base station. Managed communication may also include cellular based private networks.

Unmanaged, ad-hoc, or Peer-to-peer (P2P) communication means client devices may communicate directly (with each other or may hop through one or more other client devices without communicating through a network entity (e.g. network infrastructure such as an eNodeB, etc) for vehicle communication, such as vehicle to vehicle (V2V) and V2I. Unmanaged communication may include adhoc network that are cellular based, such as LTE-direct.

According to aspects of the disclosure, a device may have managed communication capabilities and peer-to-peer communication capabilities for short range communication, such as Bluetooth® or Wi-Fi Direct, but P2P does not mean it has unmanaged communication capabilities, such as V2V.

A trip session may be from when a vehicle is turned on to when a vehicle is turned off. In one embodiment, a trip session may be until a vehicle has reached a destination. In one embodiment, a trip session may be defined by an application, such as Uber or Lyft, so each ride provided to one or more passengers may be considered a trip session.

The features and advantages of the disclosed method and apparatus will become more apparent to those skilled in the art after considering the following detailed description in connection with the accompanying drawing.

System and techniques herein provide for generating, updating, and/or using a real-world traffic model (RTM).

As shown in FIG. 1 in a particular implementation, mobile device 100, which may also be referred to as a UE (or user equipment), may transmit radio signals to, and receive radio signals from, a wireless communication network. In one example, mobile device 100 may communicate with a cellular communication network by transmitting wireless signals to or receiving wireless signals from a cellular transceiver 110 which may comprise a wireless base transceiver subsystem (BTS), a Node B or an evolved NodeB (eNodeB) (for 5G this would be a 5G NR base station (gNodeB)) over wireless communication link 123. Similarly, mobile device 100 may transmit wireless signals to, or receive wireless signals from local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network such as those discussed in the next paragraph). Of course, these are merely examples of networks that may communicate with a mobile device over a wireless link, and claimed subject matter is not limited in this respect.

Examples of network technologies that may support wireless communication link 123 are Global System for Mobile Communications (GSM), Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). Here, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, Bluetooth (BT) and LTE.

In some embodiments, system may use, for example, a Vehicle-to-Everything (V2X) communication standard, in which information may be passed between a device and other entities coupled to a communication network, which may include wireless communication subnets. V2X services may include, for example, one or more of services for: Vehicle-to-Vehicle (V2V) communications (e.g. between vehicles via a direct communication interface such as Proximity-based Services (ProSe) Direction Communication (PC5) and/or Dedicated Short Range Communications (DSRC)) (which is considered unmanaged communication), Vehicle-to-Pedestrian (V2P) communications (e.g. between a vehicle and a User Equipment (UE) such as a mobile device) (which is considered unmanaged communication), Vehicle-to-Infrastructure (V2I) communications (e.g. between a vehicle and a base station (BS) or between a vehicle and a roadside unit (RSU)) (which is considered managed communication), and/or Vehicle-to-Network (V2N) communications (e.g. between a vehicle and an application server) (which is considered managed communication). V2X includes various modes of operation for V2X services as defined in Third Generation Partnership Project (3GPP) TS 23.285. One mode of operation may use direct wireless communications between V2X entities when the V2X entities are within range of each other. Another mode of operation may use network based wireless communication between entities. The modes of operation above may be combined or other modes of operation may be used if desired. It is important to note that this may also at least partially be a proprietary standard, a different standard or any combination thereof.

The V2X standard may be viewed as facilitating advanced driver assistance systems (ADAS), which also includes fully autonomous vehicles, other levels of vehicle automation (e.g. Level 2, Level 3, Level 4, Level 5), or automation and coordination not currently defined in autonomous vehicle automation levels. Depending on capabilities, an ADAS may make driving decisions (e.g. navigation, lane changes, determining safe distances between vehicles, cruising/overtaking speed, braking, parking, platooning, etc.) and/or provide drivers with actionable information to facilitate driver decision making. In some embodiments, V2X may use low latency communications thereby facilitating real time or near real time information exchange and precise positioning. As one example, positioning techniques, such as one or more of: Satellite Positioning System (SPS) based techniques (e.g. based on space vehicles 160) and/or cellular based positioning techniques such as time of arrival (TOA), time difference of arrival (TDOA) or observed time difference of arrival (OTDOA), may be enhanced using V2X assistance information. V2X communications may thus help in achieving and providing a high degree of safety for moving vehicles, pedestrians, etc.

In a particular implementation, cellular transceiver 110 and/or local transceiver 115 may communicate with servers 140, 150 and/or 155 over a network 130 through links 145. Here, network 130 may comprise any combination of wired or wireless links and may include cellular transceiver 110 and/or local transceiver 115 and/or servers 140, 150 and 155. In a particular implementation, network 130 may comprise Internet Protocol (IP) or other infrastructure capable of facilitating communication between mobile device 100 and servers 140, 150 or 155 through local transceiver 115 or cellular transceiver 110. Network 130 may also facilitate communication between mobile device 100, servers 140, 150 and/or 155 and a public safety answering point (PSAP) 160, for example through communications link 165). In an implementation, network 130 may comprise cellular communication network infrastructure such as, for example, a base station controller or packet based or circuit based switching center (not shown) to facilitate mobile cellular communication with mobile device 100. In a particular implementation, network 130 may comprise local area network (LAN) elements such as WLAN APs, routers and bridges and may in that case include or have links to gateway elements that provide access to wide area networks such as the Internet. In other implementations, network 130 may comprise a LAN and may or may not have access to a wide area network but may not provide any such access (if supported) to mobile device 100. In some implementations network 130 may comprise multiple networks (e.g., one or more wireless networks and/or the Internet). In one embodiment, network 130 may include one or more serving gateways or Packet Data Network gateways. In addition, one or more of servers 140, 150 and 155 may be an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) in network 130.

In particular implementations, and as discussed below, mobile device 100 may have circuitry and processing resources capable of obtaining location related measurements (e.g. for signals received from GPS or other Satellite Positioning System (SPS) satellites 114, cellular transceiver 110 or local transceiver 115 and possibly computing a position fix or estimated location of mobile device 100 based on these location related measurements. In some implementations, location related measurements obtained by mobile device 100 may be transferred to a location server such as an enhanced serving mobile location center (E-SMLC) or SUPL location platform (SLP) (e.g. which may be one of servers 140, 150 and 155) after which the location server may estimate or determine a location for mobile device 100 based on the measurements. In the presently illustrated example, location related measurements obtained by mobile device 100 may include measurements of signals (124) received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110). Mobile device 100 or a separate location server may then obtain a location estimate for mobile device 100 based on these location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at mobile device 100 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at mobile device 100. Here, servers 140, 150 or 155 may be capable of providing positioning assistance data to mobile device 100 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, servers 140, 150 or 155 may comprise an almanac which indicates locations and identities of cellular transceivers and/or local transceivers in a particular region or regions such as a particular venue, and may provide information descriptive of signals transmitted by a cellular base station or AP such as transmission power and signal timing. In the case of E-CID, a mobile device 100 may obtain measurements of signal strengths for signals received from cellular transceiver 110 and/or local transceiver 115 and/or may obtain a round trip signal propagation time (RTT) between mobile device 100 and a cellular transceiver 110 or local transceiver 115. A mobile device 100 may use these measurements together with assistance data (e.g. terrestrial almanac data or GNSS satellite data such as GNSS Almanac and/or GNSS Ephemeris information) received from a server 140, 150 or 155 to determine a location for mobile device 100 or may transfer the measurements to a server 140, 150 or 155 to perform the same determination.

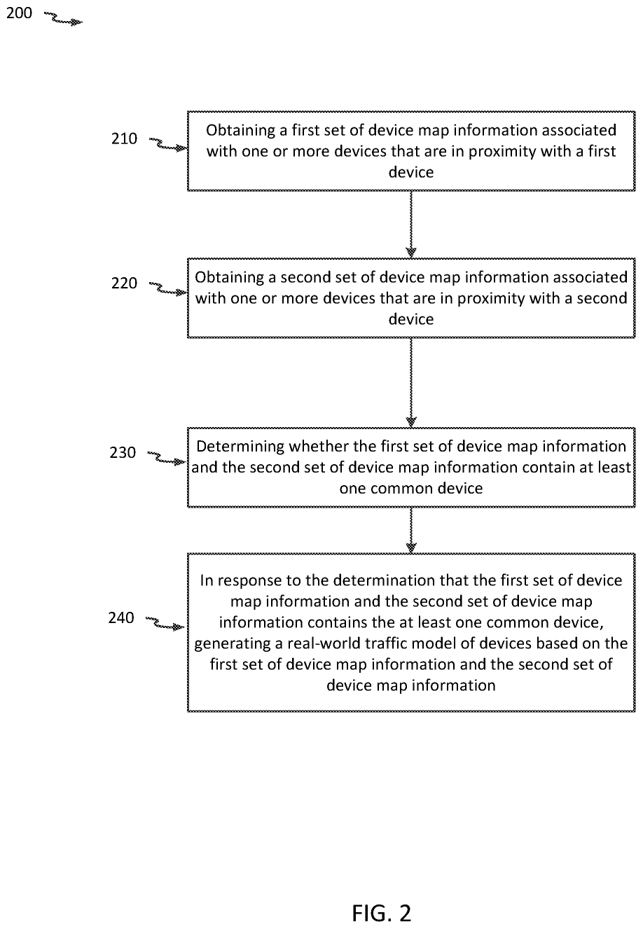

FIG. 2 is a process diagram 200 illustrating an example method of generating and/or updating a RTM.

At block 210, a mobile device 100 and/or a server 140 obtains a first set of device map information associated with one or more devices that are in proximity with a first device. A first device may be a mobile device 100 (e.g. a vehicle, a smartphone, etc.) or wireless infrastructure (e.g. an access point 115, base station 110, road station unit (RSU), etc.). The first device determines which devices are in proximity with it either via wireless communication, cameras, sensors, LiDAR, etc.

A device map information may include one or more position information for each device and one or more device identification for each device. For example, the device map information may specific a vehicle that includes absolute coordinates for the vehicle and the vehicle's license plate as an identifier.

In one embodiment, the device map information may also include the ego device's (e.g. reporting device's) position. The position may be absolute coordinates (e.g. latitude and longitude); cross streets; visible base station, access points, RSUs; recently passed intersections; lane position (e.g. what lane the vehicle is on); or any combination thereof.

Position information at a specified time may be ranging (e.g. distance relative to subject vehicle at some time) and/or orientation. The term “relative pose” is also used to refer to the position and orientation of a vehicle relative to a current position of a subject vehicle. The term “relative pose” may refer to a 6 Degrees-of-Freedom (DoF) pose of an object (e.g. target vehicle) relative to a frame of reference centered on a current position of a subject (e.g. subject vehicle). The term relative pose pertains to both the position (e.g. X, Y, Z coordinates) and orientation (e.g. roll, pitch, and yaw). The coordinate system may be centered: (a) on the subject vehicle, or (b) on image sensor(s) obtaining images of the target vehicles). In addition, because vehicular motion on roads is typically planar (i.e. the vertical motion is constrained) over short distances, the pose may also be expressed, in some instances, in lesser degrees of freedom (e.g. 3 DoF). Lowering the degrees of freedom available may facilitate computations of target vehicle distance, target vehicle relative pose, and other position parameters related to the target vehicle.

The one or more position information may comprise range, orientation, range angle, RF characteristics, absolute coordinates, velocity, position uncertainty, confidence level, position measurements or any combination thereof.

For example, the position information may include a range, which indicates a distance from the ego device or another device (e.g. a relative position). This may be expressed in any unit and/or any resolution. For example, it may be expressed as meters, centimeters, inches, etc.

The position information may comprise an orientation. For example, the reporting device may report the orientation of the object or measured device relative to the reporting device and/or it may provide an absolute orientation (e.g. relative to magnetic north).

In an embodiment, the position information may comprise a vector that includes a range and a range angle. The vector may be relative to the ego device, an object or another device. For example, the vector may be relative to a billboard along a highway.

In an example, the position information may comprise RF characteristics. The RF characteristics may comprise signal strength, round trip time, time difference of arrival, doppler shift or any combination thereof.

In an example, the position information may comprise absolute coordinates. The absolute coordinates may be in latitude, longitude and/or elevation. The absolute coordinates may be Cartesian coordinates.

The terms “Doppler shift,” or “Doppler frequency shift,” or “Doppler effect,” pertain to an observed change in frequency of a received signal (e.g. at a receiver) relative to the frequency of the transmitted signal (e.g. by a transmitter) on account of relative motion between the receiver and the transmitter. Doppler measurements may be used to determine range rate between a subject vehicle (e.g. receiver of V2V communications) and a target vehicle (e.g. transmitter of V2V communications). Range rate pertains to the rate at which the range or distance between the subject vehicle and target vehicle changes over some time period. Because nominal frequency bands for V2X, cellular, and other communications are known, the Doppler shift may be determined and used to calculate range rate and other motion related parameters.

The position information may also include position location characteristics, such as position uncertainty and/or confidence level. For example, position uncertainty may include horizontal dilution of precision. The confidence level may indicate the confidence the ego device may have in the position estimate, the technology used to make the measurement or any combination thereof.

The device identification may comprise a globally unique identifier, a locally unique identifier, a proximity unique identifier, a relatively unique identifier, one or more device identification characteristics or any combination thereof.

A globally unique identifier may include a globally unique license plate, a license plate with a region identifier, a medium access control (MAC) address, vehicle identification information (VIN) and/or some other identifier. The region identifier may indicate where the license plate identifier was issued thereby making it globally unique. For example, a license plate “5LOF455” may have been issued in California, so the license plate with the region identifier of California resulted in a globally unique identifier.

A locally unique identifier may include a license plate, a VIN, or some other identifier. A locally unique identifier is capable of being used again in a different region. For example, a license plate identifier, such as “5LOF455”, may be unique within California, but it can also be repeated in a different region, such as Washington. The region may be of any size or shape. For example, the region may be a continent, country, state, province, county, zip code, neighborhood, street, cross streets, etc.

A proximity unique identifier may be a unique identifier within a distance and/or time threshold. For example, a device may report a nearby vehicle that is likely to be unique within a hundred meters. As an example, a device may report a nearby vehicle that is likely to be unique within thirty seconds. The distance threshold and the time threshold may be of any unit and/or resolution.

A relatively unique identifier may be a unique identifier for a device as determined by the ego device. For example, a wireless road side unit (RSU) may communicate with multiple vehicles and assign them a unique IP address while they are in communication with the RSU, so the devices may have a relatively unique identifier (e.g. IP address).

In one embodiment, the device identifier may include one or more device characteristics. The device characteristics may comprise make, model, color of the device, device year, device trim, one or more dimensions of the device, shape of the device, one or more capabilities of the device (e.g., turning radius), one or more observable characteristics of the device, software type or version of the ADAS system, trip related information (e.g. passenger count, current location, destination), vehicle behavior (vector acceleration, velocity, location, braking status, turn light status, reverse lights status, etc.), other information (e.g., urgency code—such as late to work, vehicle use code such as newspaper delivery, garbage truck, sightseeing/tourism, taxi, etc.). or any combination thereof.

For example, the ego device may identify a nearby subject vehicle as being a Honda Civic and determine it is the only Honda Civic nearby or within line of sight of the ego device. The ego device may then use “Honda Civic” as a device identifier.

The ego device may identify two nearby vehicles that are both Honda Civics, but may use the color of the vehicle to further differentiate it (e.g. one vehicle is black and the other vehicle is silver).

In another example, there may be two vehicles that are both Honda Civics, but can be differentiated based on their year and/or trim. For example, one Honda Civic may be a 2018 model, but the other Honda Civic may be a 2005 model. In one embodiment, the form factor for a vehicle may be similar across multiple years, so instead of providing a specific year, it may provide a range of potential years.

Additionally, the color of the year may be used to identify or narrow down the potential year of manufacture (or selling year) that could be associated with the vehicle. For example, beige may be a color choice for a first year, but it is unavailable for the next three years for that form factor.

In one embodiment, there may be slight changes to the form factor that may be used to identify the year of manufacture (or selling year). For example, there may be slight tweaks to the rims/hubcaps, lights, etc.

The device trim may also be used to identify the device. For example, a first vehicle may be the same make and model of a second vehicle; however, the first vehicle may be standard trim, but the second vehicle may be a luxury trim, which may be indicated based on various factors, such as the headlights, roof configuration (e.g. panoramic roof, cross bars, etc), spoiler, manufacturer's markings, etc.

The device dimension(s) may be used to identify a nearby vehicle, such as width, height, length, form factor (e.g. vehicle type), 3D model of the vehicle, or any combination thereof. For example, there may be two similar vehicles, such as they have the same make and/or model, but one vehicle may have been modified (e.g. tow package) that results in it having a different dimension versus the other vehicle. The different dimensions may then be used to distinguish the two vehicles. This may be a temporary distinguishing identifier until the two vehicles are no longer in proximity or until the temporary distinguishing identifier is no longer needed.

In one embodiment, the ego device may report nearby devices using a device identifier based on rules specified by car manufacturer, original equipment manufacturer (OEM), jurisdiction, other ego devices, a server or any combination thereof. For example, Honda may specify that all their devices report nearby devices using device characteristics (e.g. make, model, year, color, etc). In another example, an OEM may specify that the ego device report nearby devices using the nearby device's license plate.

The ego device may report identified nearby devices based on the jurisdiction. For example, if the ego device is in California, it may use California rules (that may be used to comply with California and/or United States laws), to report identified nearby device (e.g. device characteristics). In another example, if the ego device has been manufactured for a particular jurisdiction or is in a particular jurisdiction (e.g. China) it may report identified nearby devices using VIN and/or license plates or the jurisdictions policy (e.g. IP Address and IP Address is temporary and changed every ten miles).

The ego device may report identified nearby devices based on how other ego devices are reporting their nearby device. For example, if a first ego device reports nearby devices using device characteristics, then the second ego device may use device characteristics to report nearby devices as well. In another example, if a first ego device reports nearby devices using device characteristics, but a second ego device reports nearby devices using license plates then the first ego device may adjust and report nearby devices also using license plates.

The ego device may also report identified nearby devices based on instructions from a server or other nearby device with proper rights (e.g., law enforcement, emergency response). For example, the server may instruct all ego devices in a particular area to report back nearby devices using device characteristics. In some circumstances, the server may instruct ego devices to report back using a different device identifier (e.g. license plates). This may be useful when there is ambiguity among the device identifier or in the case of an emergency.

In one embodiment, the ego device may also report non-devices in addition to the nearby devices. For example, it may determine device map information that also include pedestrians, bicyclists, signs, road conditions, traffic lights, etc. It is important to note that some traffic lights may include functionality that enables it to be a RSU or server, in that case then the traffic light would be included as a device, but a traffic light that is unable to communicate with nearby devices and/or sense nearby devices then those would be classified under a non-device; this is similar for these other non-devices, such as pedestrians, bicycles, etc. In one embodiment, if the pedestrian and/or bicyclist is carrying a device that is identified by the ego device then it may be reported as a device, but it may also report the non-device (e.g. pedestrian) and it may provide a device identifier and/or the non-device identifier (e.g. pedestrian's color shirt).

According to an aspect of the disclosure, the non-device information may also include characteristics. For example, an ego device may determine characteristics associated with traffic lights at an intersection, such as the traffic light state (e.g. red, yellow, green), light intensity, whether it is blinking or not, etc. These characteristics can be provided the device map information and may be provided in the RTM so a second device may make decisions based on this information. For example, if the traffic light has been green for a minute, the RTM indicates vehicles near the intersection have been moving for the last minute, but the car in front of the second vehicle is not then the second vehicle may use determine, via its behavior/route planning (which may also include motion and path planning) component, that the second vehicle to move into another lane. Additionally, this information may be provided to third parties, such as operators of the traffic lights (e.g. cities, municipalities) for various purposes, such as but not limited to determine when traffic lights need to be replaced, when they are unreliable, etc.

There may also be a plurality of devices co-located with a transport vehicle. In that circumstance, one or more of those devices may report device map information or it may elect a leader or head device that collates this information before it is sent to a device that is not co-located with the transport vehicle. For example, there may be four users, each with a smartphone, in a single vehicle so each device may be used to identify nearby device and non-devices and this information may be sent to a device to generate an RTM.

The ego device may report its capabilities and/or shortcomings as part of the device map information and/or separately. For example, the ego device, may be a vehicle, and it may indicate that it only has front facing cameras, so it is unable to detect nearby devices that are not in front of it.

In another example, the ego device may indicate it has front facing cameras, GNSS, ultrasound sensors around the device and a forward-facing radar system. In this scenario, this indicates that the ego device may have a reliable uncertainty value associated with its location (because of the GNSS receiver), but that it may only see devices that are in front of it because the ultrasound sensor may require close proximity to detect other nearby devices.

The ego device may indicate one or more areas that it is able to sense and/or one or more areas where it is able to identify nearby devices and/or non-devices. This may be indicated based on cardinal directions, intercardinal directions, angles relative to a cardinal or intercardinal direction (e.g. north), etc. For example, if the ego device has a front facing camera and a back facing camera, it may indicate it is able to sense or identify nearby devices and/or non-devices from north-west to north east and south. This information may be indicated in the device map information and/or separately.

In one embodiment, the ego device may indicate one or more areas that it is not able to sensor and/or one or more areas where it is not able to identify nearby devices and/or non-device and may be similarly performed as described above and throughout the specification.

The ego device may provide reliability information related to the device's capabilities. For example, if the ego device determines that the forward facing camera intermittently is unable to receive image data then the ego device may determine a reliability score based on when it is unable to receive image data, whether it is able to receive image data currently, whether other sensors detect an object that has not or was not identified in the image data, etc. In another example, the ego device may determine that the camera image data in unable to detect any objects during some weather conditions (e.g. rain, snow, fog, etc.) or timing related to weather conditions (e.g. within the first thirty minutes of the turning on the device when the weather condition is present), so the ego device may set a low reliability score for the device's camera capabilities. This information may be indicated in the device map information and/or separately.

In one embodiment, the ego device that is identifying nearby devices, may augment its identification information and/or characterization information of one or more nearby devices based on information from the nearby device. For example, the nearby device may have managed communication capabilities (but does not have unmanaged communication capabilities) where it can provide information about itself, such as model, make, color, etc. It may also provide position information, such as latitude/longitude, landmarks, cross streets, etc. It is important the note the nearby device may report a general vicinity or a precise position with a large uncertainty to account for potential movement of the nearby device (and potential movement until the next potential report). The ego device may retrieve this information and adjust its classification of the nearby device based on this information. For example, if the ego device has determined the nearby device is a “Black Honda Accord”, but the retrieved information indicates the only Honda Accord in the ego's vicinity is a “Blue Honda Accord”, the ego may change its device classification to the “Blue Honda Accord”. In one embodiment, the ego device may indicate in the device classification information about this change, because another device may perceive the same vehicle as black when in fact it is blue, so this can avoid ambiguity when the RTM is generated and used.

In one embodiment, the server may receive device characteristics, trip related information, vehicle behavior information and/or position information of the nearby device from the nearby device and the server may augment information about the nearby device in the device map information received from the ego device.

Additionally, the server may receive information related to areas where measurements have been received and it may indicate that no vehicles were present. The server may receive this information from RSUs, pedestrians, etc.

According to an aspect of the disclosure, each ego device may report identified nearby devices using different identifiers. For example, a first ego device may report a nearby device using device characteristics and a second ego device may report the same nearby device using a license plate.

At block 220, a mobile device 100 and/or a server 140 obtains a second set or more sets of device map information associated with one or more devices that are in proximity with a second device. A second device may be a mobile device 100 (e.g. a vehicle, a smartphone, etc.) or wireless infrastructure (e.g. an access point 115, base station 110, road station unit (RSU), edge device, etc). The first device determines which devices are in proximity with it either via wireless communication, cameras, sensors, LiDAR, etc.

At block 230, a mobile device 100 and/or a server 140 determines whether the first set of device map information and the second set of device map information contains at least one common device. In one embodiment, the device may identify one or more common devices based on the identifier.

According to an aspect of the disclosure, the determination of whether a device is a common device may be based on a comparison of one or more characteristics corresponding to a device in a first set of devices and one or more characteristics corresponding to a device in the second set of devices. For example, the mobile device 100 and/or server 140 may find a device in the first set of device map information that includes the following characteristics: “Honda”, “Civic”, “black”, “2018” and a device in the second set of device map information includes the same characteristics then the mobile 100 and/or server 140 may classify the device in the first set of device map information and the second set of device map information as the same device and therefore a common device between the two sets of device map information. The characteristics may be based on LiDAR data or any combination of LiDAR data, ultrasound data, radar data and/or camera data. The form factor may be detected based on the LiDAR data, other sensor data or any combination and the device characteristics may be derived from the form factor (e.g. “2015-2018 Honda Civic”).

In one embodiment, the determination of whether a device is a common device is based on a proximity of the device in the first set of device map information and the proximity of a device in the second set of device map information. For example, a mobile device 100 and/or server 140 may identify whether a device is a common device based on a position of a first set of device map information device and a position of a second set of device map information. If the positions are similar or in close proximity that may require the devices to overlap one another then the mobile device 100 and/or the server 140 may classify the first set of device map information device and the second set of device map information device as the same device (e.g. common device).

According to an aspect of the disclosure, the mobile device 100 and/or server 140 may determine whether the first set of device map information and the second set of device map information contain the at least one common device further comprises determining whether a timestamp of the first set of device map information and a timestamp of the second set of device map information are within a time threshold. For example, if the first set of device map information is a few minutes older than the second set of device map information but the time threshold is up to one minute then the mobile device 100 and/or server 140 may ignore any common devices found first set of device map information until an updated version is obtained.

In one embodiment, the device may use additional information to identify one or more common devices, such as if it identifies a common device ambiguity.

In one embodiment, the real-world map may be used to determine an updated identifier for a vehicle. For example, after a real-world map has been generated, a device may determine that an identifier for a nearby device may be ambiguous in light of other nearby devices. While an identifier may be a “Honda Civic” after the map has been generated, the device may determine the same or similar identifier appear to correspond to two different devices. This may occur because different devices are reporting the same identifier, but the different devices would be unable to see the same device. For example, if device with the identifier is several miles away from a second device with the same identifier, then the ambiguity may be corrected and/or noted and the devices may be annotated or the identifier may be changed to account for the ambiguity. For example, the ambiguity may be resolved by providing a location identifier or the identifying device identifier, such as between different streets, different exits, within a particular number of feet or miles, etc. In the above example of the ambiguous “Honda Civic” the device may separate the two “Honda Civics” that are separated by a few miles, the first “Honda Civic” may be given a location identifier and an identifying device identifier of being within a mile of the identifying device A and the second “Honda Civic” may have a location identifier of being at or more than two miles. Additional information may also be provided, such as it is a sedan or it is not a semi-truck, the additional information may be what the device may be positively identified as or associated with but the information may also include what the device is not. For example, it may identify the vehicle as a Honda Civic, but it may not be able to identify the year or range of years, but it may be able to identify particular features of the vehicle to identify what years it cannot be associated with, such as the hubcaps used were only associated with years after 2000, so it cannot be a pre-2000 vehicle.

In one embodiment, the ego device may not be able to differentiate between two similar vehicles that are far away, so it may have to rely on license plate information, which may pose a privacy concern, so it may mitigate privacy concerns by looking at the first character, first potion of the license plate number, last character, last portion of the license plate number, jurisdiction, the design of the license plate, registration year, etc.

Additionally, a mobile device 100 and/or a server 140 may identify ambiguous common device identifiers based on the plurality of common devices and a road map. For example, if two devices have the same identifier then the ambiguity may be identified based on the road map (e.g. first identifier is at a different street or cross streets compared to another identifier).

The road map may also be used to bound the identifier. For example, it may limit the identifier to streets, cross streets, range, etc. This may be useful for limiting an identifier that may be considered ambiguous if there are one or more similar vehicles.

In one embodiment, the real-world map may provide non-vehicle information in proximity to the reporting device. The non-vehicle information may comprise road conditions, potential accidents, lane or street congestion, or any combination thereof. This may be generated by each device that reports a device map and the real-world map when generated by incorporate the non-vehicle information into the real-world map.

This non-vehicle information may be generated utilizing sensors co-located with the device and/or the device's on-board sensors. For example, speed information (e.g. wheel ticks from vehicle, on-board computer for vehicle report speed information, doppler information from GNSS and/or wireless terrestrial communication, motion sensor, etc) may be used to determine street congestion. This information may be compared to previous speed, speed limits for the street, historical speeds for the street, etc. This information may be augmented from image sensors and/or GNSS receiver to determine lane congestion.

According to an aspect of the disclosure, the real-world map may provide device information, such as emergency vehicle, vehicle's priority information, or any combination thereof.

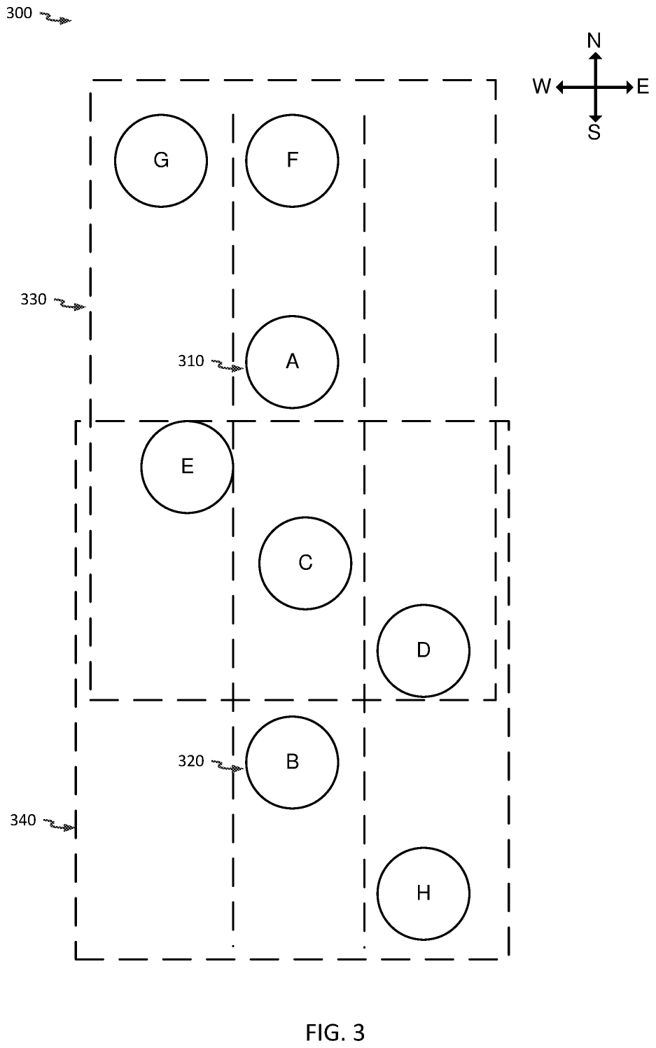

As an example, FIG. 3 shows a map 300 of devices A, B, C, D, E, F, G, H in a three-lane road traveling in the same direction. Device A is identifying and/or determining which devices are in proximity to it and determines a first set of device map information 330 that contains devices C, D, E, F, and G. Device B is identifying and/or determining which devices are in proximity to it and determines a second set of device map information 340 that contains devices C, D, E, and H. Device B may not be aware of device G and F because they are outside the range threshold (whether it is artificially limited and/or physically limited based on sensors, etc) or it may be because they are not in line of sight of device B. Similarly, device A may not be aware of device H because it is outside the range threshold or it may be because device H is not in light of sight of device A. The mobile device 100 (e.g. device A, device B or another device) and/or the server 140 may determine whether the first set of device map information 330 and the second set of device map information 340 contain one or more common devices. In this case, since device E, C, and D may be identified are common devices between the two sets of device map information. The mobile device 100 and/or the server 140 may also identify the common devices based on the coarse position of device A and B to confirm that those common devices are likely to be the same device.

At block 240, a mobile device 100 and/or a server 140, in response to the determination that the first set of device map information and the second set of device map information contain at least one common device, generating a RTM of devices based on the first set of device map information and the second set of device map information.

For example, the device (e.g. mobile device 100) may generate the RTM by using the common devices to combine the two or more sets of device map information. This may involve utilizing the common devices as anchors to join the two or more sets of device map information together or absolute coordinates (e.g., via GNSS, etc.). It may also use orientation information, direction of travel, range threshold, line of sight or any combination thereof.

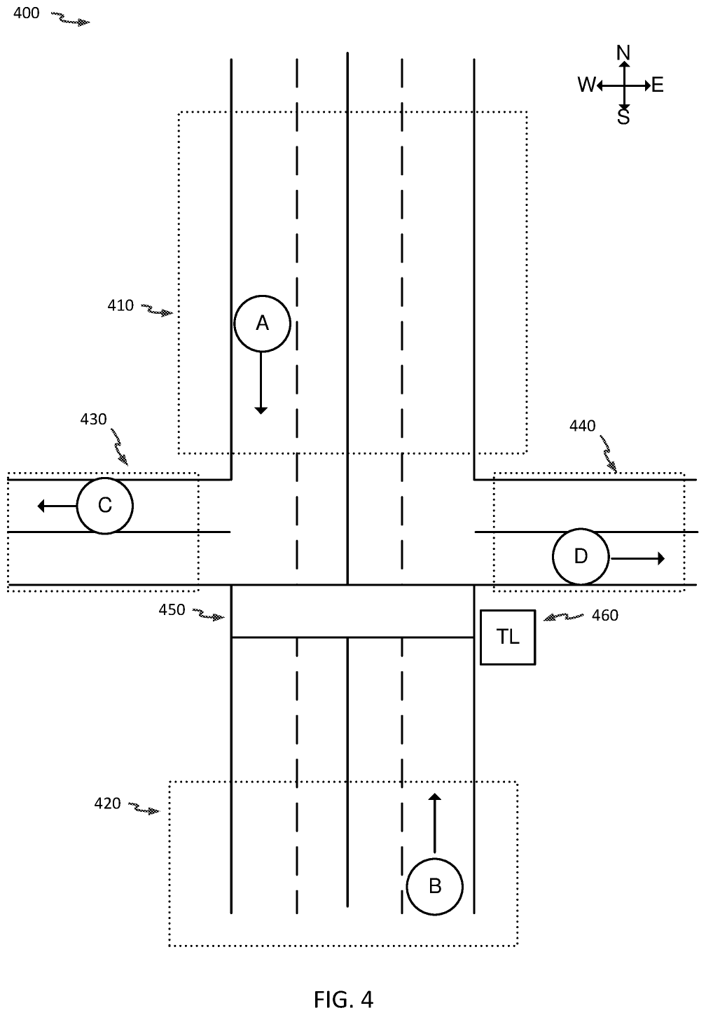

As an example, FIG. 4 shows a map 400 of devices with device A moving south, device B moving north, device C moving west and device D moving east. The streets moving east west are two single lanes with one lane moving west and the other lane moving east. The streets moving north south include two roads that each have two lanes with one road with a direction from north to south and a second road with a direction from south to north. The mobile device 100 and/or the server 140 may generate a RTM similar to the map 400 of devices. In another example, the mobile device 100 and/or the server 140 may generate four RTMs where a first RTM is limited to a first section of the map 410 that corresponds to the north section, a second section of the map 420 that corresponds to the south section, a third section of the map 430 that correspond to the west section, and a fourth section of the map 440 that corresponds to the east section. In one embodiment, there may be multiple RTMs that correspond to the direction of travel, so the road (which includes both lanes) that includes device A may all be part of a single RTM; whereas, a second RTM may be the road that includes device B. According to an aspect of the disclosure, the may be multiple RTM where the RTM may be limited to a range threshold (e.g. a hundred meters, one mile, etc).

In one embodiment, the device map information may include the traffic light 460. It may include information from a traffic light 460 and/or pedestrian devices or pedestrians that are crossing a crosswalk 450. The traffic light 460 may also be an RSU. The traffic light 460 may coordinate vehicle traffic, pedestrian traffic and/or the interaction between the two. An RSU that is not collocated with the traffic light 460 may control the traffic light 460 and how the traffic light 460 coordinates vehicle traffic, pedestrian traffic and/or the interaction between the two. The traffic light 460 may determine when pedestrians can walk across the crosswalk 450, when vehicles, such as Vehicle B, can proceed through the crosswalk 450, when vehicles should wait and not proceed through the crosswalk 450 or any combination thereof. While not included in the Figure, the device map information may also include signs, as a non-device. Vehicle B may indicate in the device map information that the RSU is coordinating traffic and it will specific when the vehicle is allowed to go. In the example of a vehicle that lacks unmanaged communication capabilities, such as communication with an RSU, this information may be used to alert the driver of the vehicle that they may have to take control of the vehicle, because the traffic lights and/or the RSU will be indicating when it'll be able to proceed.

In one embodiment, the device (e.g. mobile device 100) may filter one or more sets of device map information related to devices based on direction of travel, proximity, line of sight or any combination thereof. For example, the device may remove devices that are traveling in a different direction from the mobile device 100 (or a different target device) or the direction of the RTM (e.g. there may be one RTM going in one direction, and a second RTM going in a different direction). In one embodiment, the mobile device 100 and/or server 140 may generate a plurality of RTMs wherein each RTM corresponds to a direction of travel, proximity threshold, street, cross streets, or any combination thereof.

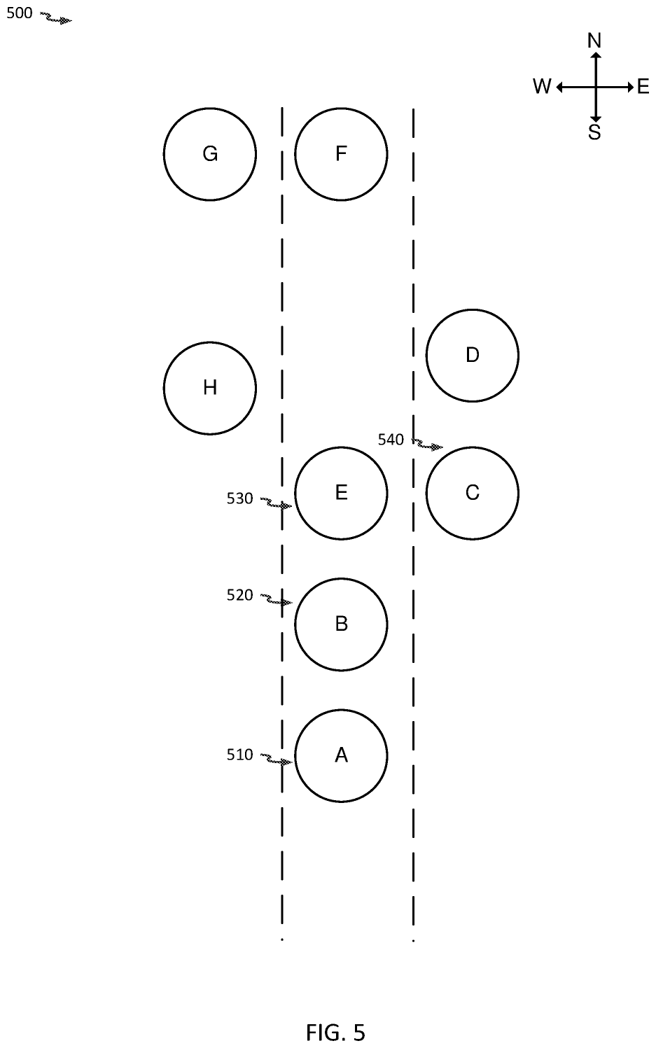

FIG. 5 illustrates an example of a RTM 500. The ego device (Device A) 510 may identify Device B 520, Device C 540 and Device H. The ego device 510 may have wireless communication capabilities to be able to share this information to a server 140 and/or other devices. Device A 510 and Device C 540 may be the only devices that are capable of sharing information to generate RTM 500.

The benefit of generating RTM 500 is it allows a mobile device and/or a server to generate a holistic RTM 500 of most if not all nearby devices and non-devices, such as pedestrians, bicyclists, etc., (and areas that have been “scanned” and that do not have nearby devices and/or non-devices) and not just the devices that have specific capabilities (i.e. wireless communications), so it allows for a map of ADAS devices, non-ADAS device and ADAS devices without wireless capabilities. For example, if Device A 510 and Device C 540 are ADAS devices but the rest are not, Device A 510 may be moving at a high speed, Device B may quickly move into another lane while Device E 530 slams on its brakes. Under conventional ADAS systems, Device A 510 would be unaware of Device E 530 until after Device B 520 had moved out of the way so Device A 510 had an unobstructed line of sight view of Device E 530 and was able to detect and classify Device E 530 as a vehicle, meaning it will waste precious time detecting the vehicle when Device A 510 could have used that extra time for braking However, under the RTM 500 since Device A 510 is already aware that Device E 530 is immediately in front of Device B 520 (because of device map information from Device C 540) then Device A 510 may slow down based on actions taken by Device E 530 that are reported by Device C 540,it may be able to quickly act upon actions performed by Device E 530 (e.g. suddenly stopping) or use device classifier information about Device E 530 to estimate a distance to the Device E 530 even with no view or partial view of the device. This system allows for a safer, more efficient, flexible travel system.

Additionally, the RTM allows for relevant information to be shared, such as trajectory of a pedestrian, etc. This allows for vehicles be more aware of their surroundings without having them to rediscover an aspect of the environment that was already determined by another device, so this potentially improves the processing efficiency for each device and the system overall. This also may reduce power consumption, latency, improve reliability and confidence of sensor information, and improve functionality (e.g. new use cases, new functions, etc).

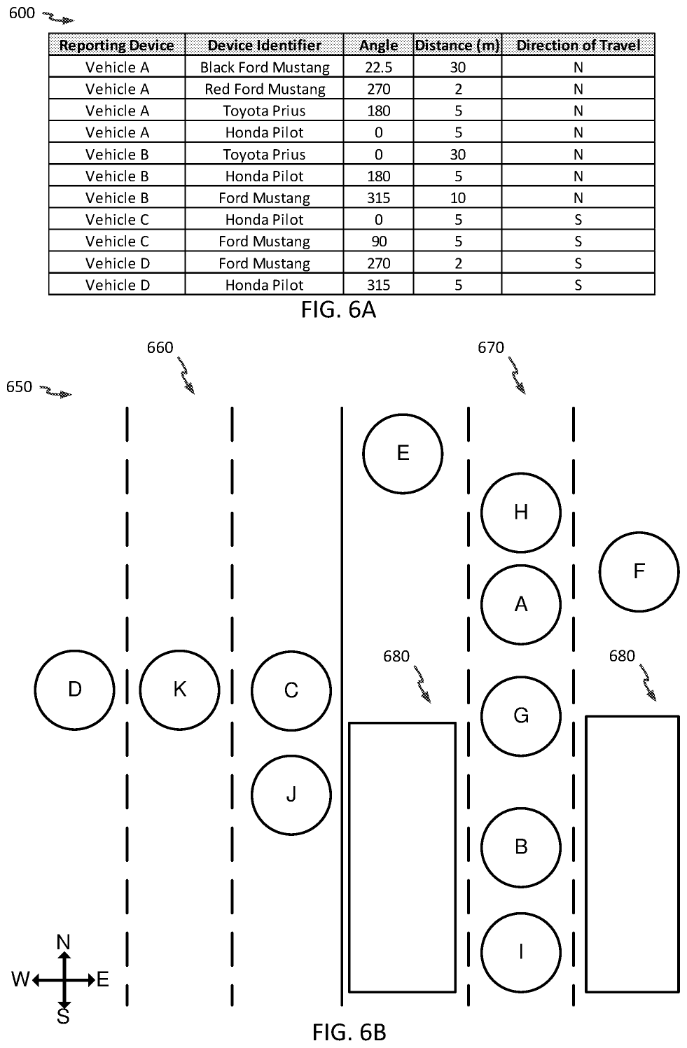

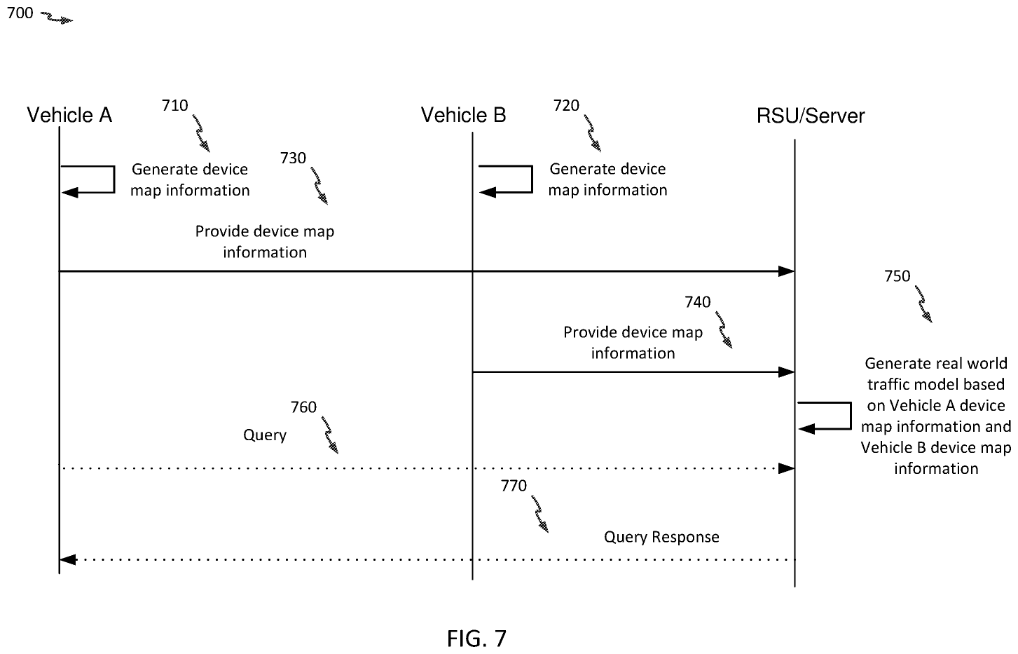

FIG. 6A is an example of device map information 600 in a table format. The device map information 600 shows the reporting device (e.g. ego device), the device identifier, the angle relative to the reporting device, distance from the reporting device, and the direction of travel of the nearby device.

There may be additional information, different information or less information that is provided in the device map information (as described throughout the specification). For example, it may include position information for the reporting device (e.g. a coarse position, precise position, etc). This position information may also be provided separately from the device map information.

In this device map information 600 example, Vehicle A reports a nearby device with the identifier “Honda Pilot” that is five meters in front of it (i.e., zero degrees north azimuth), but Vehicle B also reports a nearby device with identifier “Honda Pilot” that is five meters behind it (i.e., one hundred and eighty degrees). If that was the only common device, the device may determine that Vehicle B is in front of Vehicle A with a “Honda Pilot” vehicle between them. However, in this example, since there is a “Toyota Prius” that is reported by Vehicle A and Vehicle B and there is a “Ford Mustang” reported by Vehicle B that may be the same vehicle as the “Black Ford Mustang” that was reported by Vehicle A, these two devices would cause inconsistency with the “Honda Pilot” reported by both vehicles so the device may determine that there is ambiguity with the “Honda Pilot” and instead the “Toyota Prius” and “Ford Mustang” are used as the common devices to join the device map information. In some embodiments, after this ambiguity is identified the device may notify the reporting device to obtain a more precise device identifier to disambiguate it from the other device that had the same identifier.

In some embodiments, the device identifier may have unique device characteristics, such as roof mounted rack, but the device does not have to recognize the object. It may just provide key features, dimensions, position relative to the vehicle or any combination thereof. For example, if it is a roof mounted rack, it may provide an approximated width and height values along, key features, and it is on top of the identified vehicle (e.g. on top of a “2013 Honda Accord”).

According to an aspect of the disclosure, a subject device may be occluded that does not allow the ego device to identify the device. In these circumstances, the ego device may still report approximated position information for the subject device but the device identifier may be listed as unknown, null, or a random value until identification can be performed.

A subject device may also be unable to be identified for various reasons, such as it doesn't correspond to the make and model information associated with the vehicle. This scenario occurs for modified vehicles or custom vehicles. In this circumstance, each ego vehicle may capture various perspectives of the custom/modified vehicle (which may be captured as different times) and these different images from different perspectives may be used by an ego vehicle, RSU and/or server to determine a form factor and/or dimensions for the custom/modified vehicle.

The device map information may be provided to a mobile device 100 and/or a server 140. In a mobile centric approach, the device map information 600 may be provided to a mobile device 100 (via point to point communication and/or broadcast communication). The mobile device 100 may identify nearby device and obtain device map information from other reporting devices. In one embodiment, each reporting device may obtain device map information from other reporting devices, so it can generate its own RTM. According to an aspect of the disclosure, each reporting device may provide the device map information to particular mobile device, which uses this information to generate a RTM and distributes it to each of the reporting devices.

In a server centric approach, the device map information 600 may be provided from each reporting device to a server 140. The server may be remote from the location of the reporting devices or may be in proximity to the reporting devices (e.g. traffic light, RSU, etc). The server 140 may generate a RTM based on the obtained device map information. In one embodiment, the server 140 may provide the RTM to the reporting device and/or other devices.

According to an aspect of the disclosure, a device may request information from the server 140, and the server 140 may generate a response based on the RTM. For example, a device may request a dynamic route of travel to a destination from the server 140, so the server 140 may update the route of travel based on real-time or near real-time RTM.

There may also be a hybrid approach that provides the device map information to a mobile device 100 and a server 140, and/or partitions information and sends part of the information to the mobile device 100 and another part of the information to the server 140. In one example, the reporting devices may broadcast device map information to nearby device, including a particular mobile device 100. The mobile device 100 may generate a RTM based on the device map information, and the mobile device 100 may send to a server 140 (either via point-to-point or broadcast) the local RTM. The server 140 may use the local RTM from different locations to generate a larger RTM that may helpful for various reasons, such as route planning, emergency vehicle routing, etc.

In one embodiment, reporting devices may identify vehicle traveling in the opposite direction or in a direction different from the reporting device. For example, Vehicle B may identify Vehicle J and Vehicle C that are in the southbound road.

FIG. 6B is an example map 650 of devices illustrating one or more RTMs. There are two directions of travel on the map 650, the north bound traffic 670 shows a three-lane road and the sound bound traffic 660 shows a different three lane road. This map 650 is generated based on the device map information 600 from FIG. 6A. Vehicle A is a reporting device and Vehicle H corresponds to “Honda Pilot”, Vehicle F corresponds to “Black Ford Mustang”, Vehicle E corresponds to “Red Ford Mustang”, and Vehicle G corresponds to “Toyota Prius”. Vehicle B is a reporting device and Vehicle G correspond to “Toyota Prius”, Vehicle F corresponds to “Ford Mustang” and Vehicle I correspond to “Honda Pilot”. In the southbound road, Vehicle C is a reporting device, Vehicle J corresponds to “Honda Pilot” and Vehicle K corresponds to “Ford Mustang”. Finally, Vehicle D is a reporting device and identifies Vehicle J and Vehicle K.

Additionally, areas 680 are shown to indicate “blind spot” areas for Vehicle B, meaning one or more sensors are not capable or are unable to identify devices in these areas, because it may only have a front facing camera and a back facing camera, so it is able to see Vehicles G, F and I (Vehicle E being occluded because of Vehicle G). The real-world traffic map may use this information to indicate that these areas are not monitored. If a vehicle near areas 680 obtains the RTM, they may dedicate additional processing to monitor those areas to ensure there are no devices or non-devices in the area. The areas 680 may be determined based on the RTM, device map information, capability information from each device, reliability information from each device or any combination thereof.

In one embodiment, a device may obtain RTM 650 and adjust one or more of its sensors or co-located sensors based on the real-world traffic map 650. For example, Vehicle G may prioritize sensing devices towards the sides of Vehicle G, because the RTM 650 already indicates Vehicle A in front of it and Vehicle B behind it. Vehicle G may have a higher quasi-periodic sensing rate for the sides and have a lower quasi-periodic sensing rate for in front and behind it. Since Vehicle G may be aware of the areas 680 not being monitored, then Vehicle G may set the highest quasi-periodic sensing rate for areas 680. The sensing rate may vary based on each sensor or it may use the same rate. Additionally, the one or more groups of sensors may be triggered to sense simultaneously or may be asynchronous. In some embodiments, the device may disable its sensors (or co-located sensors) quasi-periodically.

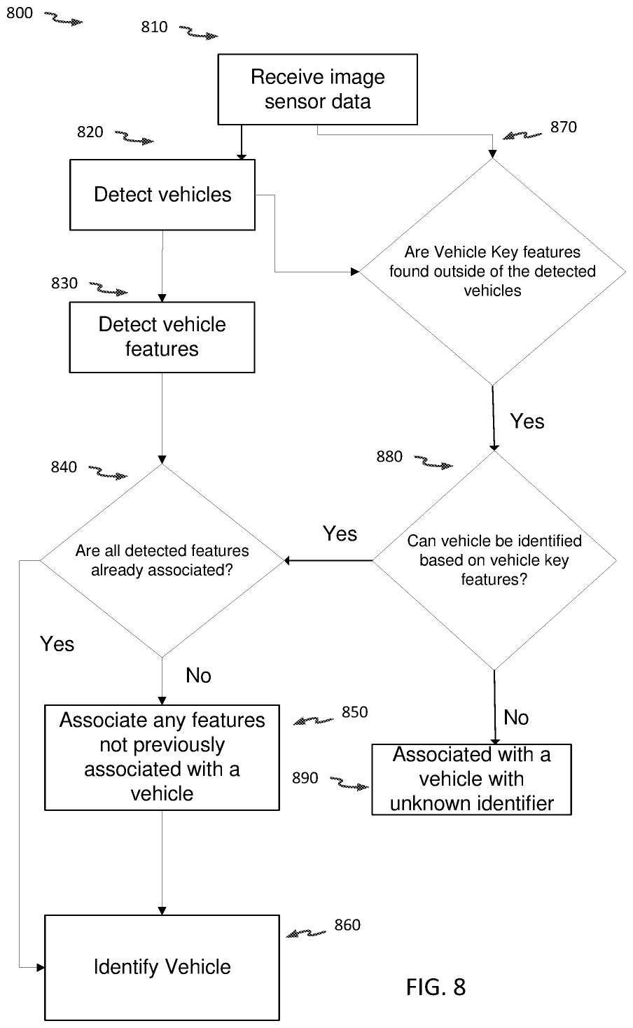

FIG. 7 is an example call flow diagram illustrating a method of generating, updating and/or querying an RTM.

The call flow 700 shows an example of Vehicle A generating device map information 710 and providing the device map information 730 to an RSU and/or server. This is similarly done for Vehicle B which generates device map information from its perspective 720 and provides this device map information 740 to an RSU and/or server. In one embodiment, Vehicle A and/or Vehicle B may have been able to send this information to another vehicle instead of or in combination with an RSU and/or server. In one embodiment, this communication may be point-to-point communication between the vehicle and another entity (e.g. RSU/server directly or through one or more intermediaries) or broadcast communication.

In a broadcast communication setting, each vehicle may broadcast its device map information and a receiving vehicle or RSU may use the broadcast information from a plurality of vehicles to generate an RTM 750.

In a point-to-point communication setting, each vehicle may establish a communication channel with the RSU and/or server (or a vehicle if that configuration is enabled) and it may provide the device map information. This may be done by a plurality of vehicles, and the RSU and/or server may generate an RTM 750 based on a plurality of device map information from at least two different devices.

In one embodiment, the device generating the RTM may start to generate an RTM when it has device map information from at least two different devices. The device may generate the RTM based on when a common device is identified in the plurality of device map information.

In one embodiment, a non-reporting device may receive device map information that was generated by another device and in that scenario, the non-reporting device may use this information for its own purposes. For example, it may identify itself in the device map information and determine potential hazards or maneuvers that may be performed based on this information. For example, the non-reporting device may be attempting to change lanes, but the device map information may indicate a vehicle is speeding up in the lane the non-reporting device is attempting to change lanes in to so an alert may be issued to avoid a potential accident or provide caution to the driver.

After an RTM has been generated 750, the RSU and/or server may provide the RTM to devices in the area. This may be provided in an unsolicited manner, meaning a device may not need to request the RTM. In one embodiment, the RSU and/or server may provide the RTM to the devices that reported device map information.

The RSU and/or server may provide the RTM (e.g. query response 770) to a device that requests this information (e.g. query 760). This is an example of a solicited request of the RTM.

The RTM may be provided to a device either via a push or a pull response. In a push response, the RTM is pushed from the RSU/Server (or nearby vehicle) to the device/vehicle when it become available without needing the device to make a specific request every time is needed (instead it may be an initial setup exchange to initiate the push responses). In a pull response, the RTM may be pulled from the RSU/Server when the device requests this information (e.g. device makes this request each time it for this information).

In one embodiment, a device may query information from another device that may be derived from the RTM without the requesting device needing to receive the RTM. For example, in FIG. 6B, Vehicle A may query the RTM from the RSU/server to find out if traffic is moving up ahead, because its view is occluded by Vehicle H and it may find out that vehicles up ahead are traveling at a significantly slower speed in a few miles. This information may be provided to the driver of Vehicle A, if it is a driver assistant system, or it may be provided to a self-driving controller if it is in an autonomous driving mode, so that in either scenario action can be taken based on this information (e.g. slowing down).

The device may also query information about itself or the transport vehicle co-located with the device. For example, a transport vehicle may identify that its fuel efficiency has dropped or one of its sensors are indicating an unusual drag on the vehicle as it is moving, so it may query the RTM to provide information about its body. This information may be readily available in the RTM, or it may require an additional query that is sent out to multiple vehicles that are nearby and able to report that information to perform this additional search.

For example, referring to FIG. 6B, if it is Vehicle A but all of the nearby vehicles do not contain the capability to provide this information directly to Vehicle A but they are able to transmit this information to a server, then Vehicle A can query the RTM on the server to obtain this information. In this scenario, the server can send requests to each of the nearby vehicles, Vehicles G, F, H and E to obtain multiple images of Vehicle A and the vehicles are use a method to identify potential differences in the images versus what is expected of Vehicle A and provide that to the server or the vehicles can provide the image data to a server and the server can make that determination. The image data may be compared against image features, previous image data, two dimensional or three-dimensional models of Vehicle A (that may be provided and/or maintained by Vehicle A or an OEM) or any combination thereof. The comparison may be used to identify any differences and that can be reported to Vehicle A. This may be used for any number of purposes or use cases, such as “are the brake lights works”, “is cargo in truck bed properly secured?”, etc.

In one embodiment, a third party may provide one or more key features or a key features database that can be used to provide a response in some of these use cases, such as “is the cargo in truck bed properly secured.” These key features may be provided by the company associated with the truck to ensure their employees are following properly protocol and procedure, may be provided by one or more services (e.g. imaging services), one or more third parties (e.g. highway authority, OEMs, etc) or any combination thereof.

In one embodiment, nearby devices may report information about a device and/or to report the device. For example, if there is a company vehicle where the cargo to the truck bed is moving and doesn't appear to be secured then this information may be generated by a nearby device and reported to a server. The server may provide this information to the company, a third party and/or a reporting agency (e.g. police, highway authority, etc). This information may include the location, vehicle identification information, and/or image or video data.

In one embodiment, a road may have five lanes going in the same direction, a device may obtain a portion of an RTM associated with the road. The device may query the RSU/server 760, requesting a portion of an RTM associated with specific lanes. In one embodiment, the RSU/server 760 may receive a request for the RTM by the device and based on the lane associated with the device, the RSU/server may provide a portion of the RTM associated with the road and/or lane associated with the device. For example, it may obtain only the RTM for the lane it is traveling on and the lanes adjacent to the device, so it instead of RTM for all five lanes, it may obtain RTM for three lanes. Of course, the portion of the RTM may also be distance bound or similarly bound (e.g. cross streets, etc).

In one embodiment, a device may request a portion of the RTM based on the route of travel. For example, if the device has already determined or received the route of travel to a destination, the device may request an RTM associated with the route of travel. The RTM associated with the route of travel may be used to adjust the route of travel.

The device's position along the route of travel may be used determine the portion of the RTM to provide to the device. For example, the portion of the RTM may exclude the route of travel that has already been traversed by the device.

The portion of the RTM may also be limited based on the distance the device is expected to traverse, one or more time thresholds or any combination thereof. For example, the server and/or device generating the RTM may provide the requesting device with a portion of the RTM that is limited to a mile around the requesting device. It is important to note that portion of the RTM may be limited to a first threshold in front of the requesting device and a different threshold behind the requesting device. It may similarly include different thresholds to the left or right of the requesting device.

In one embodiment, the requesting device may quasi-periodically request and/or be provided with the RTM (or updates to the RTM) in proximity to the requesting device. In one embodiment, the requesting device may request and/or be provided with the RTM (or updates to the RTM) in proximity to the requesting device based on changes to the RTM in proximity with the requesting device. The requesting device may request and/or be provided with the RTM (or updates to the RTM) in proximity to the requesting device based on the requesting device's proximity to cross streets, freeway entrances/exits, merging lanes or any combination thereof.

The requesting device may request and/or be provided with the RTM (or update to the RTM) in proximity to the requesting device based on time (e.g. absolute time, relative time, compared to a time threshold). Absolute time may be UTC time, pacific standard time, etc. Relative time may be time since the requesting device last receive or was provided with an RTM or may be a counter.

In one embodiment, the requesting device may request and/or be provided with the RTM or updates for the RTM based on motion of the requesting device.

In one embodiment, the requesting device may request and/or be provided with the RTM or updates for the RTM based on any combination of the techniques listed above. For example, a requesting device may request an update for the RTM based on time and its proximity to cross streets.

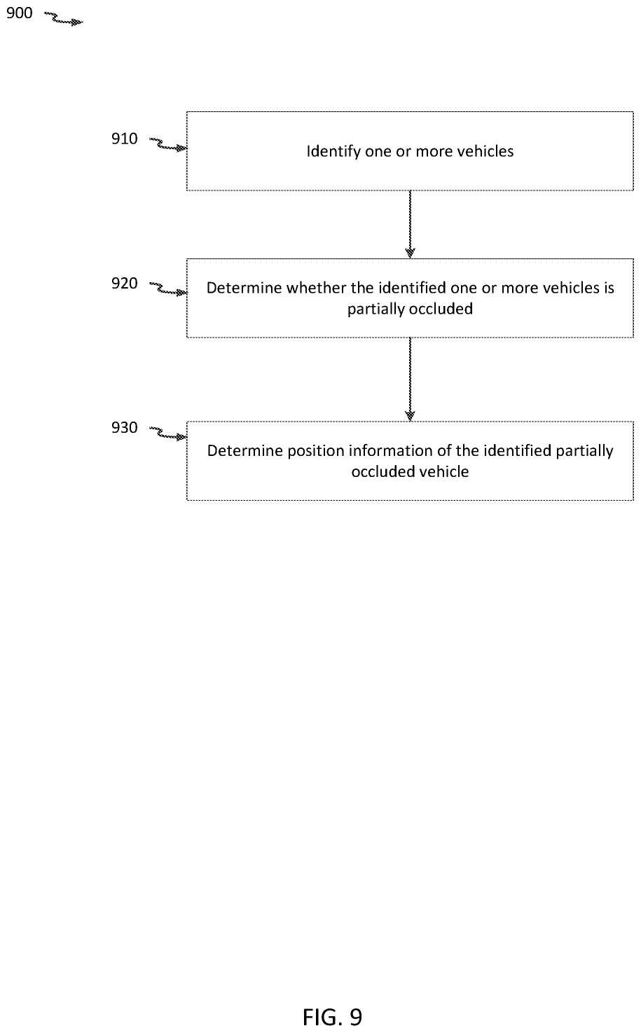

FIG. 8 is an example process diagram 800 for identifying one or more vehicles. At block 810, image sensor data from one or more cameras is received. The image sensor data may contain images of nearby vehicles, pedestrians, signs, etc.

At block 820, the received image sensor data may be used to detect whether or not there are any vehicles in the received image sensor data. If there are any vehicles detected, then each detected vehicle provided to block 830. These vehicles may be detected in a similar manner to what is done currently, where a generic vehicle detector is used to detect vehicle in image sensor data. The generic vehicle detector is usually an inference that has been developed, via deep learning training and old image data, to detect a vehicle with new image data.

At block 830, for each detected vehicle each of its features are detected. This may allow for features that are unique to that specific vehicle to be detected and used for identification purposes at a later time.

At block 840, the detected features from block 830 for a particular vehicle is compared against a vehicle feature database to determine whether that particular detected vehicle has already been associated with all of the detected features. If any of the features have not already been associated with the detected vehicle, then it proceeds to block 850. If all of the features have already been associated with that detected vehicle, then it proceeds to block 860. This process is done for each detected vehicle. As will be discussed later, this feature detection is also performed for detected vehicle key features that are not associated with a detected vehicle. Once a vehicle has been identified the ego device may attach a 2D or 3D bounding box to the identified vehicle. The 3D bounding box can be pinned based on the detected features of the identified vehicle, and may be based on the identified vehicle parameters (e.g. height, width, length based on make, model, or any other device characteristics).

These features may include additional parameters, such as but not limited to reliability, uniqueness, time since last seen, whether feature was used to attach a form factor or any combination thereof.

At block 850, the features that were detected but not previously associated with the detected vehicle then the features are then associated with the detected vehicle. This may be done in any number of ways including but not limited to storing the features or pointers to the features in a database and indicating the associated detected vehicle.

At block 860, the features are used to identify the vehicle. These features may also be used to track the vehicle, and/or be used to determine position information relative to the ego device.

After the vehicle has been identified, the ego device may use associated key features to continue to detect, identify and/or track the vehicle without needing to first detect the vehicle via a generic vehicle detector. So even if the vehicle disappears from the ego vehicles view but later reappears into view, the ego vehicle does not have to start the vehicle detection process again, it could use one or more key features associated with each nearby vehicle to check if the nearby vehicle is still present. This enables a potentially quicker and more reliable identification and detection process and thereby reduces potential collisions.

In one embodiment, the ego vehicle can predict or estimate which key features are likely to be visible for a nearby previously detected vehicle based on the nearby vehicle's lane position, vehicle's form factor, vehicle's dimensions, the ego vehicle's dimensions, the ego vehicle's sensor positions or any combination thereof.

For example, if a nearby vehicle is in lane to the right of the ego vehicle and they are traveling in the same direction, the ego vehicle may select key features for the nearby vehicle that are associated with the left face and back face of the nearby vehicle and may prioritize key features that are towards the top of the vehicle. When the image sensor data is received, then the prioritized key features may be searched for first and the lower portions of the left face and back face of the nearby vehicle may then be search. The key feature searching is merely an example, another non-limited example may be training a deep learning model based on the nearby vehicle and/or all of the nearby vehicles that have been identified and/or detected in a particular time period (e.g. trip session, seen in the RTM, etc), the inference classifier, based on the trained deep learning model, may then be used to detect these identified vehicle. This may run in parallel and/or sequentially with the generic vehicle detector and/or any other inference classifiers.

At block 870, the ego device and/or server/RSU may determine whether there are any vehicle key features in the image sensor data that are not part of the detected vehicles based on the detected vehicles and the image sensor data. These key features may be associated with vehicles are occluded and traditionally are unable to be detected via the generic vehicle detectors. If there are no vehicle feature that are not outside of the detected vehicles, then it does not proceed, and the process starts again when new image sensor data. If vehicle features are detected outside of the detected vehicles, then it proceeds to block 880.

At block 880, the ego device and/or server/RSU may determine whether a vehicle can be identified based on the vehicle features detected in block 870. If a vehicle can be identified based on the key features, then it proceeds to block 840. The key features may have already been associated with a vehicle that was previously detected and identified by the ego device and/or was/is part of the RTM. If the vehicle cannot be identified based on the key features, then it proceeds to block 890.

At block 840, if the vehicle can be identified based on the key features then a check is performed to determine if the vehicle has been associated with all of the key features. For example, it may have been identified based on the majority of the key features (identifying key features), but if there are non-identifying key features that are in close proximity with these identifying key features (and/or meets one or more threshold criteria) then the non-identifying key features should be associated with the vehicle and it can proceed to block 850 (and subsequently to block 860) similar to when a vehicle is detected initially.

If a vehicle cannot be identified based on the key features from block 880 then it proceeds to block 890. If the key features are in close proximity (and/or meets one or more threshold criteria) then the key features are associated with an “unknown” identifier so this vehicle can still be tracked until it can be identified. The “unknown” identifier may be a random number, random identifier, the term “unknown” or null with a number to indicate the number of unknown vehicles that are being detected/tracked, etc.

In one embodiment, if the key features are not in close proximity with one another or there are different clusters of key features, then the key features may be separated accordingly and a similar approach as described above may be used. There may other criteria that can be used to determine whether or not the key features should be associated and/or grouped together, such as but not limited to number of features, uniqueness of the features, proximity of the features to a detected vehicle, number of times features have been seen in a time period (or with a number of frames threshold), etc.

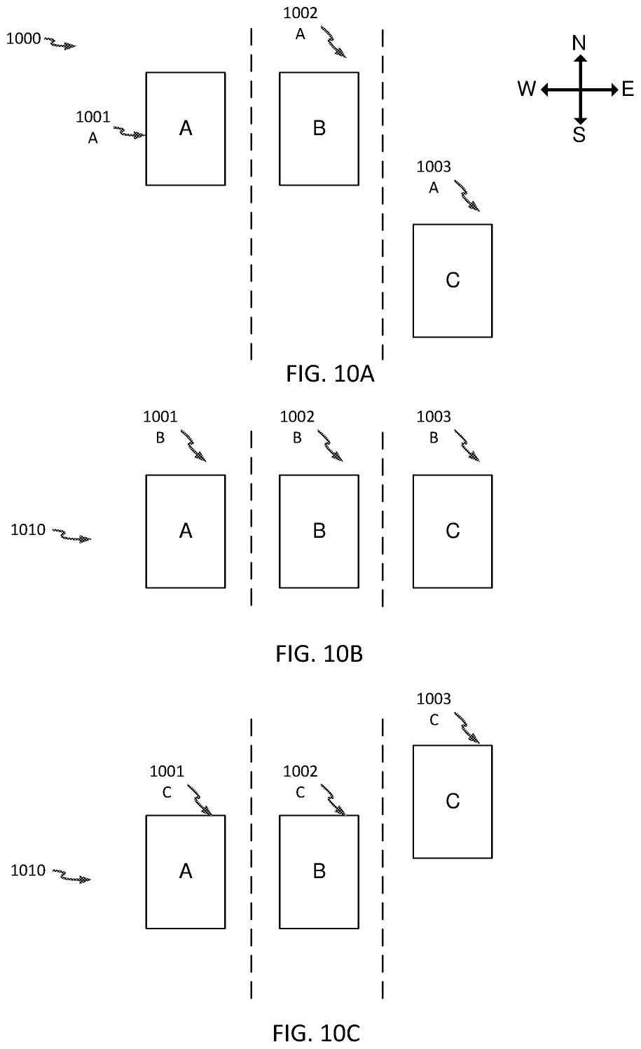

FIG. 9 is an example process diagram determining position information for a temporally occluded vehicle.

At block 910, the device identifies one or more vehicles. The device obtains one or more images from one or more image sensors and identifies the one or more vehicles based on key features, form factor, or any other information from the RTM or derived from the RTM.

At block 920, the device determines whether the identified one or more vehicles is partially occluded. This may be determined based on where the key features are located on the vehicle. For example, if key features are only seen at the top of the vehicle or the top right corner of the vehicle, then the vehicle is being occluded in some way.

In one embodiment, the device may determine whether key features were previously seen on the vehicle but are no longer seen. For example, at a previous time the device or another device was able to see key features all around the back face of the vehicle, but currently only key features at the top of the back face of the vehicle are currently seen.

In one embodiment, the device may identify a first vehicle and detect key features not associated with the first vehicle but appear to be in the same lane or trajectory as the first vehicle. The device may then determine whether the key features are associated with another vehicle from the RTM. If the key features are associated with another vehicle the device may track the vehicle accordingly. If the key features may be associated with two or more vehicles based on the RTM, then it may track the vehicle, but it may not be able to unique identify the vehicle until more key features are detected and used. In one embodiment, the device determine that the number of key features must meet or exceed a threshold value for the vehicle to be identified. Similarly, the device may determine a unique score based on the key features that indicate how unique the vehicle may be based on the detected key features, in light of the RTM for the area, and if it meets or exceeds the threshold value then the vehicle may be identified.

At block 930, the device may determine position information of the identified partially occluded vehicle. The device may determine how dimensions representing the vehicle or a three-dimensional model of the vehicle may be associated with the vehicle based on the key features. For example, if the top of the vehicle is seen and the vehicle is uniquely identified in the RTM, then the key features from the top of the vehicle may be used to associated height and width dimensions the identified vehicle (with the height and width dimensions being retrieved from, such as but not limited to, a database). This information may be used to determine an estimated orientation of the vehicle and/or estimated distance from the device to the identified vehicle.

The key features that may be used to identify a vehicle (such as a partially occluded vehicle) may be obtained as part of the RTM. If the ego device has previously identified the vehicle during the current trip session, then it may be used based on the jurisdiction. In some jurisdictions, such as China, they may allow a vehicle to keep this information stored across multiple trip sessions or as long as the vehicle has storage availability. In other jurisdictions, such as the United States of America, there may be privacy concerns, so the vehicle may flush out identifying information at the beginning and/or end of a trip session, after a predetermined amount of time, based on storage availability (e.g. limited storage buffer, such as only ten vehicles may be tracked), or any combination thereof.

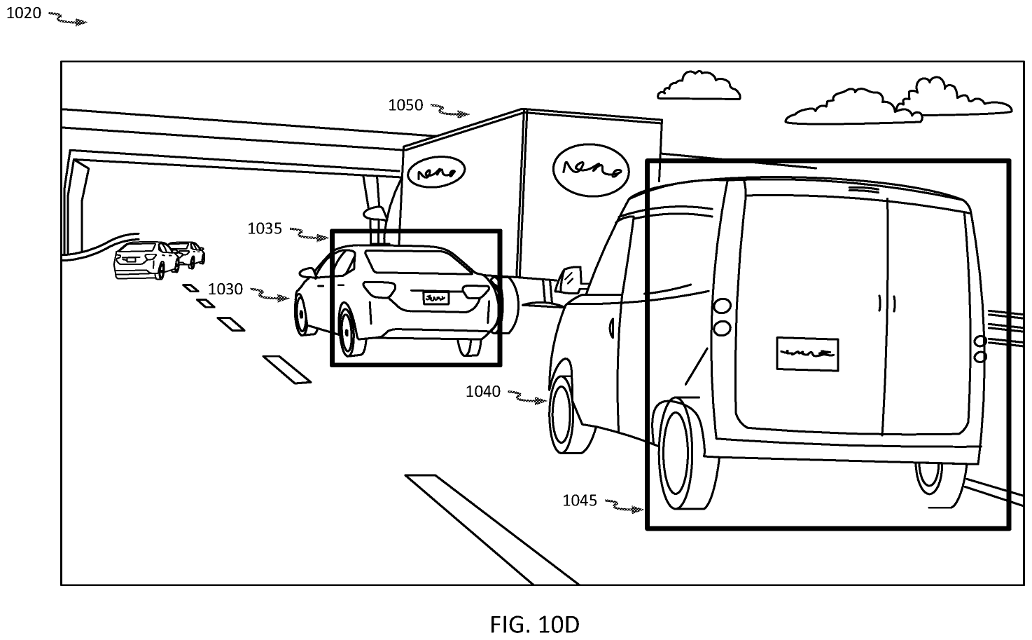

FIGS. 10A, B and C are an example map of vehicles illustrating temporal occlusion and how position information may be determined for that vehicle.

FIG. 10A shows Vehicle A 1001A using the RTM and identifying nearby vehicles to determine position information relative to these vehicles. Vehicle B 1002A is a potentially occlusion for Vehicle A 1001A for vehicles in the right lane. In the right lane is Vehicle C 1003A that is rapidly approaching Vehicles A 1001A and Vehicle B 1002A.

FIG. 10B shows Vehicle C 1003B is temporally completed occluded from Vehicle A 1001B's line of sight by Vehicle B 1002B. In this scenario, Vehicle A 1001B would be unaware that Vehicle C 1003B is being completed occluded unless if Vehicle A 1001B tracked Vehicle C 1003B until it was completed occluded. In one embodiment, a device using the RTM may track vehicles until they are completely occluded and may determine through inference that the vehicle is being occluded. The device may continue to infer the vehicle is occluded until a threshold time has passed without detect any key features associated with the occluded vehicle.

In one embodiment, the device may continue to infer the vehicle is occluded until a potential exit point has been passed. For example, if the vehicles are on a freeway, Vehicle A 1001B may infer that Vehicle C 1003B continues to be occluded because they have not passed a freeway exit, but after a freeway exit has been passed then it may need to see key features associated with Vehicle C 1003B to continue to determine that Vehicle C 1003B is being occluded.

FIG. 10C shows Vehicle C 1003C is only partially occluded by Vehicle B 1002C. In this scenario, Vehicle A 1001C may detect key features along the left face of Vehicle C 1003C and may use these key features to pin dimensions and/or a form factor to Vehicle C 1003C. After the dimensions and/or form factor for Vehicle C 1003C have been pinned to the vehicle, then Vehicle A 1001C may use this information to determine position information relative to Vehicle C 1003C.

FIG. 10D is image sensor data 1020 that may be captured from the perspective of an ego device and shows nearby Vehicles 1030 and 1040 and shows a partially occluded semi-truck 1050. From this figure, it can be seen that vehicles 1030 and 1040 has been detected by a generic vehicle detector as indicated by bounding boxes 1035 and 1045; however, there is no bounding box for the semi-truck to indicate it has not been detected by the generic vehicle detector. In this scenario, the ego device is dangerously unaware of the nearby semi-truck, so a planning and motion processor on the ego device may inadvertently plan a lane change or a course that would cause the ego device to inadvertently run into the semi-truck. It is important to note that the bounding boxes 1035 and 1045 may be two-dimensional bounding boxes or three-dimensional bounding boxes but are only illustrated here as examples as a 2D bounding box.

Instead, by using the RTM, the ego device may detect the semi-truck based on key features that have previously associated with the semi-truck by the ego device and/or other vehicles. A current RTM may inform the planning and motion processor of the ego device that even though the generic vehicle detector has not detected the semi-truck that there is a still a semi-truck in that particular space. Additionally, the ego device may proceed with detecting the semi-truck using the key features, so it can identify and/or track the semi-truck.

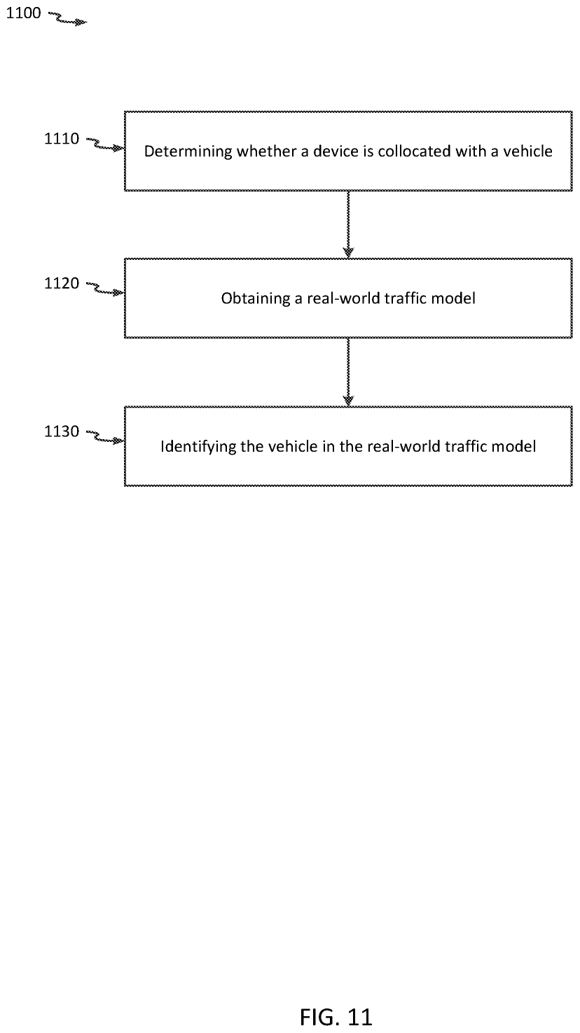

FIG. 11 is an example process diagram for registering a device that is temporally collocated with the vehicle for use with an RTM.

In one embodiment, the device, using the RTM, may be a smartphone or any mobile device that is temporarily collocated with a vehicle (e.g. automobile, bicycle, etc).

At block 1110, the device determines whether it is collocated with a vehicle. The device may determine whether it is collocated with a vehicle based on whether it is paired with the vehicle via a wireless communication interface and/or wired interface. In one embodiment, the device may determine whether it is collocated with a vehicle based on received onboard device information from the vehicle. It may also determine whether it is collocated with a vehicle based on speed and/or routes of travel. In one embodiment, the device may determine it is collocated with a vehicle based on image data, which may identify vehicle's characteristics, such as steering wheel, dashboard, etc.

At block 1120, the device may obtain RTM that corresponds to the device's location. If the vehicle knows its location, it may provide it to the device and the device may also use this information to retrieve the corresponding RTM.

At block 1130, the device identifies the collocated vehicle in the RTM. The device may be associated with identifiable vehicle information apriori based on historically information, user input or image data. For example, the user may take a picture of the vehicle, which may be used to identify make, model, etc, and the vehicle information may be obtained based on this image data. The identifiable vehicle information may be provided by the vehicle, such as through onboard device information, or may be obtained via quick response codes, radio frequency tags or similar that are attached to the vehicle.

After the identifiable vehicle information is obtained by the device, the device may use this information to identify the vehicle within the RTM. If the vehicle has only recently begun traveling or there are few or no vehicles or devices around it then it may need to quasi-periodically search for itself including RTM updates until the vehicle is identified. Once the vehicle is identified then it is considered registered and the RTM may be used by the device to provide the driver with driving assistance information. For example, it may notify them that moving into another lane will be more optimal, because a vehicle up ahead is frequently braking without reason and will cause a needless slow down.

In one embodiment, the device may use its own sensors, such as an inertial motion sensors, image sensors, etc, to provide device map information on behalf of the collocated vehicle, and use the RTM.

According to an aspect of the disclosure, if there are multiple devices that are collocated with the same vehicle each device may determine whether it wants to provide information on behalf of the vehicle. However, the device that provide driver assistance information may be selected based on the other devices, user input, image data indicating proximity to a driver or any combination thereof.

By using a temporally collocated device to provide driver assistance information using the RTM, it allows drivers to improve their safety while operating their vehicle without needing to buy a new vehicle to enable this functionality. This also means that traffic flow and time to destination may also be improved.

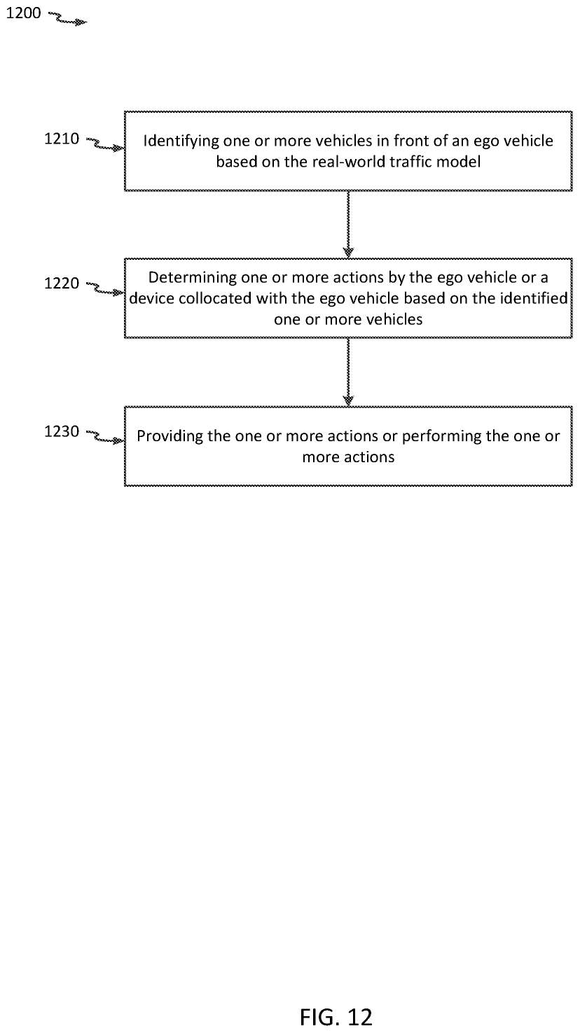

FIG. 12 is an example process diagram for utilizing an RTM in an advanced driver assistance system.

At block 1210, a mobile device, RSU and/or server may identify one or vehicles in proximity with an ego device based on the RTM. These vehicles may be identified based on safety, ego maintenance costs, time to destination, traffic, points of interest, ego vehicle's route, or any combination thereof.

For example, if a nearby vehicle is frequently braking and this information is part of the RTM, the ego vehicle and/or RSU/server may identify this vehicle as vehicle for the ego vehicle to avoid for safety concerns, increase ego's maintenance costs (e.g. which may include insurance costs), reducing time to destination, causing artificial traffic, etc. The ego vehicle may use this information or provide this information to its behavior/route planning component to further optimize the ego vehicle's route by avoiding these vehicles.

According to an aspect of the disclosure, the ego vehicle may not contribute to the RTM but instead just use the RTM. In the case where the ego vehicle provides driver assistance information or limited driving assistance but it unable to self-drive (e.g. can apply the brakes, gas or steering in limited scenarios, similar to Level 2 or 3 vehicle), the user may input information for the ego vehicle to identify itself in the RTM or the vehicle may have enough identifiable information in its on board device to identify itself in the RTM and then proceed with identifying other nearby devices in the RTM.

In one embodiment, the RTM may include safety information or vehicle intent information. For example, a first vehicle may provide device map information, but may also include that the first vehicle intends to merge lanes in the next five hundred milliseconds. An RSU or server may generate the real-world traffic map information and notify other vehicles in proximity to the first vehicle that first vehicle intends to merge in the next five hundred milliseconds. In one embodiment, the RSU may identify vehicles that may be affected by the first vehicles lane merge and the RSU may provide a message or notification specifically to those vehicles.

In another example, a passenger of an ego vehicle may request to get a closer view of the ocean, which is on the right side of the vehicle, so the ego vehicle may identify vehicles in the RTM so the ego vehicle can navigate into the right lane.

At block 1220, the mobile device, RSU and/or server may determine one or more actions by the ego vehicle or a device collocated with the ego vehicle based on the identified one or more vehicles. The ego vehicle may use the identified vehicles to determine when the ego vehicle may be able to merge into another lane, adjust speed, merge onto or off a highway/freeway, adjust orientation, etc. In one embodiment, the device and/or server may determine how to provide these actions, such as visual, haptic, auditory indicators or any combination of alerts. It may also provide where these indicators are provided, such as head mounted display, mixed reality display, virtual reality display, infotainment display, etc; how long these indicators should be provided and/or how early these indicators should be provided.

For example, if the ego vehicle is operated by a user, the device and/or server may identify the user and based on the user that providing haptic feedback and providing it four miles before the action needs to be taken for a few minutes with a follow-up visual alert a mile before the action needs to be taken until the action is taken or is no longer able to be taken is optimal for that particular user. This may be determined based on historical patterns for the user and when they were able to perform the actions vs when they were not, user input, OEM input, etc.

This may also be based on whether the action was feasible to be performed. For example, if the action is to merge lanes, but there are no open positions for the vehicle to merge over and/or the other nearby vehicles are not allowing the vehicle to merge over then the action may not be feasible so this may be ignored. This information may also be used to inform the device and/or server how early they may need to trigger vehicle to vehicle communications to initiate the action (e.g. request other nearby vehicles to open a position for ego vehicle to merge into their lane).

At block 1230, the mobile device, RSU and/or server may provide the one or more actions or perform the one or more actions. For example, the one or more actions may be provided via alerts (e.g. haptic, visual, auditory, etc) to the operator of the vehicle. If the vehicle is in an autonomous mode, the vehicle may perform these actions.

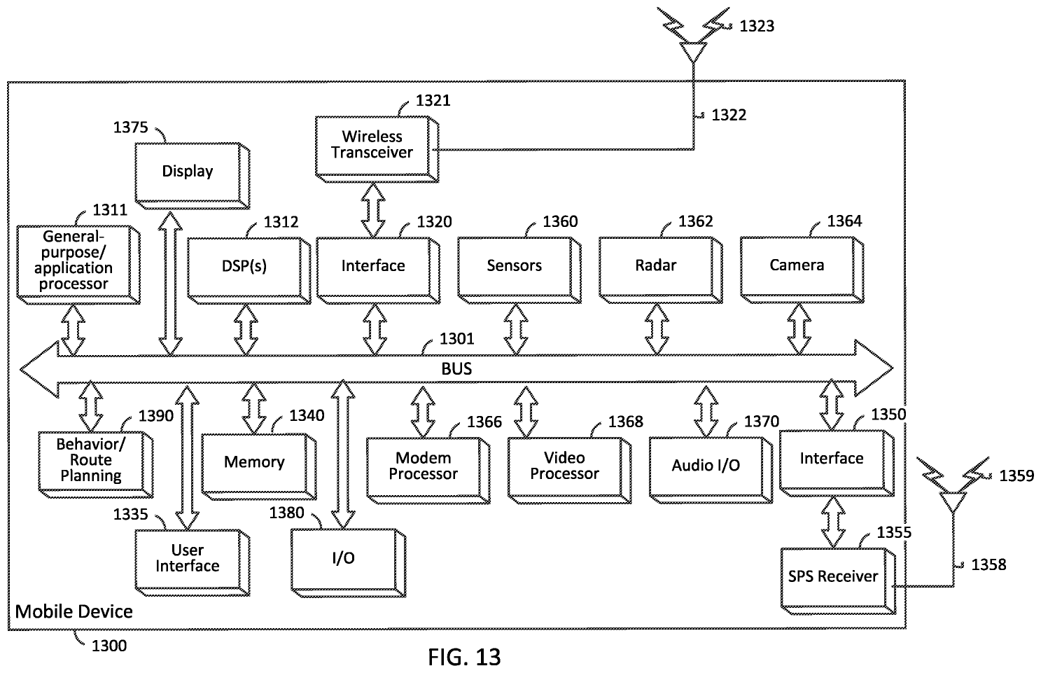

FIG. 13 is a schematic diagram of a mobile device 1300 according to an implementation. Mobile device 100 shown in FIG. 1 may comprise one or more features of mobile device 1300 shown in FIG. 13. In certain implementations, mobile device 1300 may comprise a wireless transceiver 1321 which is capable of transmitting and receiving wireless signals 1323 via wireless antenna 1322 over a wireless communication network. Wireless transceiver 1321 may be connected to bus 1301 by a wireless transceiver bus interface 1320. Wireless transceiver bus interface 1320 may, in some implementations be at least partially integrated with wireless transceiver 1321. Some implementations may include multiple wireless transceivers 1321 and wireless antennas 1322 to enable transmitting and/or receiving signals according to corresponding multiple wireless communication standards such as, for example, versions of IEEE Standard 802.11, CDMA, WCDMA, LTE, UMTS, GSM, AMPS, Zigbee, Bluetooth and a 5G or NR radio interface defined by 3GPP, just to name a few examples. In a particular implementation, wireless transceiver 1321 may transmit signals on an uplink channel and receive signals on a downlink channel as discussed above.

Mobile device 1300 may also comprise SPS receiver 1355 capable of receiving and acquiring SPS signals 1359 via SPS antenna 1358 (which may be integrated with antenna 1322 in some implementations). SPS receiver 1355 may also process, in whole or in part, acquired SPS signals 1359 for estimating a location of mobile device 1300. In some implementations, general-purpose processor(s) 1311, memory 1340, digital signal processor(s) (DSP(s)) 1312 and/or specialized processors (not shown) may also be utilized to process acquired SPS signals, in whole or in part, and/or calculate an estimated location of mobile device 1300, in conjunction with SPS receiver 1355. Storage of SPS or other signals (e.g., signals acquired from wireless transceiver 1321) or storage of measurements of these signals for use in performing positioning operations may be performed in memory 1340 or registers (not shown). General-purpose processor(s) 1311, memory 1340, DSP(s) 1312 and/or specialized processors may provide or support a location engine for use in processing measurements to estimate a location of mobile device 1300. In a particular implementation, all or portions of actions or operations set forth for process 1100 may be executed by general-purpose processor(s) 1311 or DSP(s) 1312 based on machine-readable instructions stored in memory 1340.

Also shown in FIG. 13, digital signal processor(s) (DSP(s)) 1312 and general-purpose processor(s) 1311 may be connected to memory 1340 through bus 1301. A particular bus interface (not shown) may be integrated with the DSP(s) 1312, general-purpose processor(s) 1311 and memory 1340. In various implementations, functions may be performed in response to execution of one or more machine-readable instructions stored in memory 1340 such as on a computer-readable storage medium, such as RAM, ROM, FLASH, or disc drive, just to name a few examples. The one or more instructions may be executable by general-purpose processor(s) 1311, specialized processors, graphics processing unit(s) (GPU), neural processor(s) (NPU), AI accelerator(s), or DSP(s) 1312. Memory 1340 may comprise a non-transitory processor-readable memory and/or a computer-readable memory that stores software code (programming code, instructions, etc.) that are executable by processor(s) 1311 and/or DSP(s) 1312. The processor(s) 1311 and/or the DSP(s) 1312 may be used to perform various operations as described throughout the specification.

Also shown in FIG. 13, a user interface 1335 may comprise any one of several devices such as, for example, a speaker, microphone, display device, vibration device, keyboard, touch screen, just to name a few examples. In a particular implementation, user interface 1335 may enable a user to interact with one or more applications hosted on mobile device 1300. For example, devices of user interface 1335 may store analog or digital signals on memory 1340 to be further processed by DSP(s) 1312 or general-purpose processor 1311 in response to action from a user. Similarly, applications hosted on mobile device 1300 may store analog or digital signals on memory 1340 to present an output signal to a user. In another implementation, mobile device 1300 may optionally include a dedicated audio input/output (I/O) device 1370 comprising, for example, a dedicated speaker, microphone, digital to analog circuitry, analog to digital circuitry, amplifiers and/or gain control. Audio I/O 1370 may also include ultrasound or any audio based positioning that can be used to determine the position, orientation or context of the mobile device 1300. Audio I/O 1370 may also be used to provide data via one or more audio signals to another source. It should be understood, however, that this is merely an example of how an audio I/O may be implemented in a mobile device, and that claimed subject matter is not limited in this respect.

Mobile device 1300 may also comprise a dedicated camera device 1364 for capturing still or moving imagery. Camera device 1364 may comprise, for example an imaging sensor (e.g., charge coupled device or CMOS imager), lens, analog to digital circuitry, frame buffers, just to name a few examples. In one embodiment, additional processing, conditioning, encoding or compression of signals representing captured images may be performed at general purpose/application processor 1311 or DSP(s) 1312. Alternatively, a dedicated video processor 1368 may perform conditioning, encoding, compression or manipulation of signals representing captured images. Additionally, video processor 1368 may decode/decompress stored image data for presentation on a display device (not shown) on mobile device 1300. The video processor 1368, may be an image sensor processor, and may be capable of performing computer vision operations.

Camera device 1364 may include image sensors. The image sensors may include cameras, charge coupled device (CCD) based devices, or Complementary Metal Oxide Semiconductor (CMOS) based devices, Lidar, computer vision devices, etc. on a vehicle, which may be used to obtain images of an environment around the vehicle. Image sensors, which may be still and/or video cameras, may capture a series of 2-Dimensional (2D) still and/or video image frames of an environment. In some embodiments, image sensors may take the form of a depth sensing camera, or may be coupled to depth sensors. The term “depth sensor” is used to refer to functional units that may be used to obtain depth information. In some embodiments, image sensors 232 may comprise Red-Green-Blue-Depth (RGBD) cameras, which may capture per-pixel depth (D) information when the depth sensor is enabled, in addition to color (RGB) images. In one embodiment, depth information may be obtained from stereo sensors such as a combination of an infra-red structured light projector and an infra-red camera registered to a RGB camera. In some embodiments, image sensors may be stereoscopic cameras capable of capturing 3 Dimensional (3D) images. For example, a depth sensor may form part of a passive stereo vision sensor, which may use two or more cameras to obtain depth information for a scene. The pixel coordinates of points common to both cameras in a captured scene may be used along with camera parameter information, camera pose information and/or triangulation techniques to obtain per-pixel depth information. In some embodiment, the image sensor may be capable of capturing infrared or other non-visible light (i.e. not visible to the human eye). In some embodiments, image sensor may include Lidar sensors, which may provide measurements to estimate the relative distance of objects. The camera 1364 may also be capable of receiving visual light communication data by capturing optical measurements and demodulating to receive this data. The term “camera pose” or “image sensor pose” is also used to refer to the position and orientation of an image sensor on a subject vehicle.

Mobile device 1300 may also comprise sensors 1360 coupled to bus 1301 which may include, for example, inertial sensors and environment sensors. Inertial sensors of sensors 1360 may comprise, for example accelerometers (e.g., collectively responding to acceleration of mobile device 1300 in three dimensions), one or more gyroscopes or one or more magnetometers (e.g., to support one or more compass applications). Environment sensors of mobile device 1300 may comprise, for example, temperature sensors, barometric pressure sensors, ambient light sensors, camera imagers, microphones, just to name few examples. Sensors 1360 may generate analog or digital signals that may be stored in memory 1340 and processed by DSP(s) 1312 or general-purpose application processor 1311 in support of one or more applications such as, for example, applications directed to positioning or navigation operations. The sensors 1360 may also include radar 1362, which may be used to determine the distance between the device and another object. The sensors 1360, SPS receiver 1355, wireless transceiver 1321, camera(s) 1364, audio i/o 1370, radar 1362 or any combination thereof may be used determine one or more location measurements and/or a position location of the mobile device 1300.

Mobile device 1300 may comprise one or more displays 1375 and/or one or more display controllers (not shown). The displays 1375 and/or the display controllers may provide and/or display a user interface, visual alerts, metrics, and/or other visualizations. In one embodiment, the one or more displays 1375 and/or display controllers may be integrated with the mobile device 1300.

According to another aspect of the disclosure, the one or more displays 1375 and/or display controllers may be external to the mobile device 1300. The mobile device 1300 may have one or more input and/or output ports (I/O) 1380, through a wired or wireless interface, and may use the I/O to provide data to the external one or more displays 1375 and/or display controller(s).

The I/O 1380 may be used for other purposes as well, such as but not limited to obtaining data from a vehicle's onboard diagnostics, vehicle sensors, providing sensor information from the mobile device 1300 to the external device, etc. The I/O 1380 may be used to provide data, such as position information, to another processor and/or component, such as the behavior and/or route planning component 1390.

The mobile device 1300 may include a wired interface (not shown in FIG. 13), such as ethernet, coaxial cable, controller area network (CAN), etc.

The behavior and/or route planning component 1390 may be one or more hardware components, software or any combination thereof. The behavior and/or route planning component 1390 may also be part of one or more other components, such as but not limited to one or more general purpose/application processor 1311, DSP 1312, GPU, neural processor(s) (NPU), AI accelerator(s), microcontrollers, controllers, video processor(s) 1368 or any combination thereof. The behavior and/or route planning component 1390 may determine and/or adjust vehicle speed, position, orientation, maneuvers, route, etc. The behavior and/or route planning component 1390 may trigger alerts to the user or operator of the vehicle and/or a remote party (e.g. third party, remote operator, owner of the vehicle, etc) based on the determinations related to speed, position, orientation, maneuvers, route, etc. In one embodiment, the behavior and/or route planning component 1390 may also perform one or more steps similar to those listed in FIG. 2, FIG. 7, FIG. 8, FIG. 9, FIG. 11, FIG. 12 and/or other parts of the specification.

The behavior and/or route planning component 1390, processor 1311, GPU, DSP 1312, video processor(s) 1368 or other type of processor(s), memory 1340, sensors 1360, radar(s) 1362, camera(s) 1364, wireless transceiver 1321 with modem processor 1366, audio I/O 1370, SPS receiver 1355 or any combination thereof may obtain a first set of device map information associated with one or more device, wherein the one or more devices are in proximity with a first device, similar to block 210 and step 710, 720, 730 and 740; and/or obtain a second set of device map information associated with one or more devices in proximity with a second device, similar to block 220 and step 710, 720, 730 and 740. The behavior and/or route planning component 1390, processor 1311, GPU, DSP 1312, video processor(s) 1368 or other type of processor(s), memory 1340 or any combination thereof may determine whether the first set of device map information and the second set of device map information contain at least one common device, similar to block 230; and/or in response to the determination that the first set of device map information and the second set of device map information contains at least one common device, may generate an RTM of devices based on the first set of device map information and the second set of device map information, similar to block 240 and 750.

The behavior and/or route planning component 1390, processor 1311, GPU, DSP 1312, video processor(s) 1368 or other type of processor(s), memory 1340, camera(s) 1364, wireless transceiver 1321 with modem processor 1366, audio I/O 1370, SPS receiver 1355 or any combination thereof may query the RTM, similar to step 760, and/or may provide a response to a query based on the RTM, similar to step 770.

The behavior and/or route planning component 1390, processor 1311, GPU, DSP 1312, video processor(s) 1368 or other type of processor(s), memory 1340, wireless transceiver 1321, wired interface or any combination thereof may receive image sensor data, similar to block 810; detect vehicles, similar to block 820, detect vehicle features, similar to block 830; determine whether all the features are already associated, similar to block 840; associate any features not previously associated with a vehicle to a vehicle, similar to block 850; identify a vehicle, similar to block 860; determine whether there are any vehicle key features found outside the detected vehicles, similar to block 870; determine whether a vehicle can be identified based on the vehicle key features, similar to 880; and associate the vehicle key features with an unknown identifier, similar to 890.

The behavior and/or route planning component 1390, processor 1311, GPU, DSP 1312, video processor(s) 1368 or other type of processor(s), memory 1340, sensors 1360, radar(s) 1362, camera(s) 1364, wireless transceiver 1321 with modem processor 1366, audio I/O 1370, SPS receiver 1355 or any combination thereof may identify one or more vehicles, similar to block 910; and/or may determine position information of the identified partially occluded vehicle, similar to block 930. The behavior and/or route planning component 1390, processor 1311, GPU, DSP 1312, video processor(s) 1368 or other type of processor(s), memory 1340 or any combination thereof may determine whether the identified one or more vehicles is partially occluded, similar to block 920.

The behavior and/or route planning component 1390, processor 1311, GPU, DSP 1312, video processor(s) 1368 or other type of processor(s), memory 1340, sensors 1360, camera(s) 1364, wireless transceiver 1321 with modem processor 1366, audio I/O 1370 or any combination thereof may determine whether a device is collocated with a vehicle, similar to block 1110; obtain an RTM, similar to block 1120; and/or identify the vehicle in the RTM, similar to block 1130.

The behavior and/or route planning component 1390, processor 1311, GPU, DSP 1312, video processor(s) 1368 or other type of processor(s), memory 1340 or any combination thereof may identify one or more vehicles in proximity of an ego vehicle based on the RTM, similar to block 1210; determine one or more actions by the ego vehicle or a device collocated with the ego vehicle based on the identified one or more vehicles, similar to block 1220; and/or provide the one or more actions or perform the one or more actions, similar to block 1230.

In a particular implementation, mobile device 1300 may comprise a dedicated modem processor 1366 capable of performing baseband processing of signals received and down converted at wireless transceiver 1321 or SPS receiver 1355. Similarly, modem processor 1366 may perform baseband processing of signals to be upconverted for transmission by wireless transceiver 1321. In alternative implementations, instead of having a dedicated modem processor, baseband processing may be performed by a general-purpose processor or DSP (e.g., general purpose/application processor 1311 or DSP(s) 1312). It should be understood, however, that these are merely examples of structures that may perform baseband processing, and that claimed subject matter is not limited in this respect.

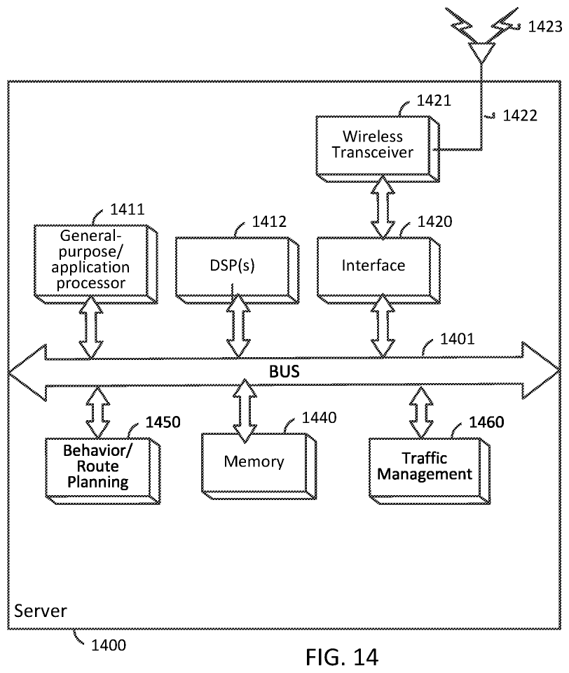

FIG. 14 is a schematic diagram of a server 1400 according to an implementation. Server 140 shown in FIG. 1 may comprise one or more features of server 1400 shown in FIG. 14. In certain implementations, server 1400 may comprise a wireless transceiver 1421 which is capable of transmitting and receiving wireless signals 1423 via wireless antenna 1422 over a wireless communication network. Wireless transceiver 1421 may be connected to bus 1401 by a wireless transceiver bus interface 1420. Wireless transceiver bus interface 1420 may, in some implementations be at least partially integrated with wireless transceiver 1421. Some implementations may include multiple wireless transceivers 1421 and wireless antennas 1422 to enable transmitting and/or receiving signals according to corresponding multiple wireless communication standards such as, for example, versions of IEEE Standard 802.11, CDMA, WCDMA, LTE, UMTS, GSM, AMPS, Zigbee, Bluetooth and a 5G or NR radio interface defined by 3GPP, just to name a few examples. In a particular implementation, wireless transceiver 1421 may transmit signals on an uplink channel and receive signals on a downlink channel as discussed above.

The server 1400 may include a wired interface (not shown in FIG. 14), such as ethernet, coaxial cable, etc.

Also shown in FIG. 14, digital signal processor(s) (DSP(s)) 1412 and general-purpose processor(s) 1411 may be connected to memory 1440 through bus 1401. A particular bus interface (not shown) may be integrated with the DSP(s) 1412, general-purpose processor(s) 1411 and memory 1440. In various implementations, functions may be performed in response to execution of one or more machine-readable instructions stored in memory 1440 such as on a computer-readable storage medium, such as RAM, ROM, FLASH, or disc drive, just to name a few examples. The one or more instructions may be executable by general-purpose processor(s) 1411, specialized processors, or DSP(s) 1412. Memory 1440 may comprise a non-transitory processor-readable memory and/or a computer-readable memory that stores software code (programming code, instructions, etc.) that are executable by processor(s) 1411 and/or DSP(s) 1412. The processor(s) 1411, specialized processor(s), graphics processing unit(s) (GPU), neural processor(s) (NPU), AI accelerator(s), microcontroller(s), controller(s) and/or the DSP(s) 1412 may be used to perform various operations as described throughout the specification.

The behavior and/or route planning component 1450 may be one or more hardware components, software or any combination thereof. The behavior and/or route planning component 1450 may also be part of one or more other components, such as but not limited to one or more general purpose/application processor 1411, DSP 1412, GPU, neural processor(s) (NPU), AI accelerator(s), microcontrollers, controllers, video processor(s) or any combination thereof. The behavior and/or route planning component 1450 may determine and/or adjust vehicle speed, position, orientation, maneuvers, route, etc. The behavior and/or route planning component 1450 may trigger alerts to the user or operator of the vehicle and/or a remote party (e.g. third party, remote operator, owner of the vehicle, etc) based on the determinations related to speed, position, orientation, maneuvers, route, etc. In one embodiment, the behavior and/or route planning component 1450 may also perform one or more steps similar to those listed in FIG. 2, FIG. 7, FIG. 8, FIG. 9, FIG. 11, FIG. 12 and/or other parts of the specification.

The traffic management controller 1460 may be one or more hardware components, software or any combination thereof. The behavior and/or route planning component 1450 may also be part of one or more other components, such as but not limited to one or more general purpose/application processor 1411, DSP 1412, GPU, neural processor(s) (NPU), AI accelerator(s), microcontrollers, controllers, video processor(s), behavior/route planning 1450 or any combination thereof. The traffic management controller 1460 may use the RTM to determine optimized routes for users based on current traffic patterns and/or predicted traffic patterns. The traffic management controller 1460 may be used by traffic lights (e.g. physical traffic lights, virtual traffic lights, etc) or operators of traffic lights to control the flow of traffic in a city, municipality, etc.

The behavior and/or route planning component 1450, processor 1411, GPU, DSP 1412, video processor(s) or other type of processor(s), memory 1440, wireless transceiver 1421, wired interface or any combination thereof may obtain a first set of device map information associated with one or more device, wherein the one or more devices are in proximity with a first device, similar to block 210 and step 710, 720, 730 and 740; obtain a second set of device map information associated with one or more devices in proximity with a second device, similar to block 220 and step 710, 720, 730 and 740; determine whether the first set of device map information and the second set of device map information contain at least one common device, similar to block 230; and/or in response to the determination that the first set of device map information and the second set of device map information contains at least one common device, may generate an RTM of devices based on the first set of device map information and the second set of device map information, similar to block 240 and 750.

The behavior and/or route planning component 1450, processor 1411, GPU, DSP 1412, video processor(s) or other type of processor(s), memory 1440, wireless transceiver 1421, wired interface or any combination thereof may query the RTM, similar to step 760, and/or may provide a response to a query based on the RTM, similar to step 770.

The behavior and/or route planning component 1450, processor 1411, GPU, DSP 1412, video processor(s) or other type of processor(s), memory 1440, wireless transceiver 1421, wired interface or any combination thereof may receive image sensor data, similar to block 810; detect vehicles, similar to block 820, detect vehicle features, similar to block 830; determine whether all the features are already associated, similar to block 840; associate any features not previously associated with a vehicle to a vehicle, similar to block 850; identify a vehicle, similar to block 860; determine whether there are any vehicle key features found outside the detected vehicles, similar to block 870; determine whether a vehicle can be identified based on the vehicle key features, similar to 880; and associate the vehicle key features with an unknown identifier, similar to 890.

The behavior and/or route planning component 1450, processor 1411, GPU, DSP 1412, video processor(s) or other type of processor(s), memory 1440, wireless transceiver 1421, wired interface or any combination thereof may identify one or more vehicles, similar to block 910; may determine position information of the identified partially occluded vehicle, similar to block 930; and/or may determine whether the identified one or more vehicles is partially occluded, similar to block 920.

The behavior and/or route planning component 1450, traffic management control 1460, processor 1411, GPU, DSP 1412, video processor(s) or other type of processor(s), memory 1440, wireless transceiver 1421, wired interface or any combination thereof may determine whether a device is collocated with a vehicle, similar to block 1110; obtain an RTM, similar to block 1120; and/or identify the vehicle in the RTM, similar to block 1130.

The behavior and/or route planning component 1450, traffic management controller 1460, processor 1411, GPU, DSP 1412, video processor(s) or other type of processor(s), memory 1440, wireless transceiver 1421, wired interface or any combination thereof may identify one or more vehicles in proximity with an ego vehicle based on the RTM, similar to block 1210; determine one or more actions by the ego vehicle or a device collocated with the ego vehicle based on the identified one or more vehicles, similar to block 1220; and/or provide the one or more actions, similar to block 1230.

Discussions of coupling between components in this specification do not require the components to be directly coupled. These components may be coupled directly or through one or more intermediaries. Additionally, coupling does not require they be directly attached, but it may also include electrically coupled, optically coupled, communicatively coupled or any combination thereof.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In another aspect, as previously mentioned, a wireless transmitter or access point may comprise a cellular transceiver device, utilized to extend cellular telephone service into a business or home. In such an implementation, one or more mobile devices may communicate with a cellular transceiver device via a code division multiple access (“CDMA”) cellular communication protocol, for example.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

What is claimed is:

1. A method of generating a real-world traffic model at a first device, the method comprising:
obtaining, at the first device, a first set of device map information associated with one or more devices that are in proximity with the first device;
obtaining, at the first device, a second set of device map information associated with one or more devices that are in proximity with a second device;
determining, at the first device, whether the first set of device map information and the second set of device map information contain at least one common device; and
in response to the determination that the first set of device map information and the second set of device map information contain the at least one common device, generating a real-world traffic model of devices, at the first device, based on the first set of device map information and the second set of device map information.

2. The method of claim 1, wherein the first set and second set of device map information comprises one or more position information for each device and one or more device identification information for each device.

3. The method of claim 2, wherein the one or more position information comprises:
range, orientation, range angle, RF characteristics, absolute coordinates, velocity, position uncertainty, confidence level or any combination thereof.

4. The method of claim 2, wherein the one or more device identification information comprises: a globally unique identifier, a locally unique identifier, a proximity unique identifier, one or more vehicle identification characteristics, or any combination thereof.

5. The method of claim 1, wherein the determining whether the first set of device map information and the second set of device map information contain the at least one common device further comprises determining whether a timestamp of the first set of device map information and a timestamp of the second set of device map information are within a time threshold.

6. The method of claim 1, wherein the generating the real-world traffic model of devices based on the first set of device map information and the second set of device map information further comprises filtering device map information related to devices based on direction of travel, proximity, line of sight, or any combination thereof.

7. The method of claim 1, wherein the generating the real-world traffic model of devices based on the first set of device map information and the second set of device map information comprises combining the first set of device map information and the second set of device map information based on the at least one common device.

8. The method of claim 7, wherein the combining the first set of device map information and the second set of device map information is further based on one or more common objects.

9. The method of claim 7, wherein the first set of device map information comprises a first set of devices and each device in the first set of devices comprises one or more device characteristics and wherein the second set of device map information comprises a second set of devices and each device in the second set of devices comprises one or more device characteristics and wherein the determining whether the first set of device map information and the second set of device map information contain the at least one common device comprises:
determining whether a device is a common device based on a comparison of one or more characteristics corresponding to a device in the first set of devices and one or more characteristics corresponding to a device in the second set of devices.

10. A first device for generating a real-world traffic model, the first device comprising:
one or more memory;
one or more transceivers;
one or more processors communicatively coupled to the one or more memory and the one or more transceivers, the one or more processors configured to:
obtain, via the one or more transceivers, a first set of device map information associated with one or more devices that are in proximity with the first device;
obtain, via the one or more transceivers, a second set of device map information associated with one or more devices that are in proximity with a second device;
determine whether the first set of device map information and the second set of device map information contain at least one common device; and
in response to the determination that the first set of device map information and the second set of device map information contain the at least one common device, generating a real-world traffic model of devices based on the first set of device map information and the second set of device map information.

11. The first device of claim 10, wherein the first set and second set of device map information comprises one or more position information for each device and one or more device identification information for each device.

12. The first device of claim 11, wherein the one or more position information comprises: range, orientation, range angle, RF characteristics, absolute coordinates, velocity, position uncertainty, confidence level or any combination thereof.

13. The first device of claim 11, wherein the one or more device identification information comprises: a globally unique identifier, a locally unique identifier, a proximity unique identifier, one or more vehicle identification characteristics, or any combination thereof.

14. The first device of claim 10, wherein the one or more processors configured to determine whether the first set of device map information and the second set of device map information contain the at least one common device is further configured to determine whether a timestamp of the first set of device map information and a timestamp of the second set of device map information are within a time threshold.

15. The first device of claim 10, wherein the one or more processors configured to generate the real-world traffic model of devices based on the first set of device map information and the second set of device map information is further configured to filter device map information related to devices based on direction of travel, proximity, line of sight, or any combination thereof.

16. The first device of claim 10, wherein the one or more processors configured to generate the real-world traffic model of devices based on the first set of device map information and the second set of device map information comprises the one or more processors configured to combine the first set of device map information and the second set of device map information based on the at least one common device.

17. The first device of claim 16, wherein the one or more processors configured to combine the first set of device map information and the second set of device map information is further based on one or more common objects.

18. The first device of claim 16, wherein the first set of device map information comprises a first set of devices and each device in the first set of devices comprises one or more device characteristics and wherein the second set of device map information comprises a second set of devices and each device in the second set of devices comprises one or more device characteristics and wherein the one or more processors configured to determine whether the first set of device map information and the second set of device map information contain the at least one common device comprises the one or more processors configured to:
determine whether a device is a common device based on a comparison of one or more characteristics corresponding to a device in the first set of devices and one or more characteristics corresponding to a device in the second set of devices.

19. A first device for generating a real-world traffic model, the first device comprising:
means for obtaining a first set of device map information associated with one or more devices that are in proximity with the first device;
means for obtaining a second set of device map information associated with one or more devices that are in proximity with a second device;
means for determining whether the first set of device map information and the second set of device map information contain at least one common device; and
in response to the determination that the first set of device map information and the second set of device map information contain the at least one common device, means for generating a real-world traffic model of devices based on the first set of device map information and the second set of device map information.

20. The first device of claim 19, wherein the first set and second set of device map information comprises one or more position information for each device and one or more device identification information for each device.

21. The first device of claim 20, wherein the one or more position information comprises: range, orientation, range angle, RF characteristics, absolute coordinates, velocity, position uncertainty, confidence level or any combination thereof.

22. The first device of claim 20, wherein the one or more device identification information comprises: a globally unique identifier, a locally unique identifier, a proximity unique identifier, one or more vehicle identification characteristics, or any combination thereof.

23. The first device of claim 19, wherein the means for determining whether the first set of device map information and the second set of device map information contain the at least one common device further comprises means for determining whether a timestamp of the first set of device map information and a timestamp of the second set of device map information are within a time threshold.

24. The first device of claim 19, wherein the means for generating the real-world traffic model of devices based on the first set of device map information and the second set of device map information further comprises means for filtering device map information related to devices based on direction of travel, proximity, line of sight, or any combination thereof.

25. The first device of claim 19, wherein the means for generating the real-world traffic model of devices based on the first set of device map information and the second set of device map information comprises means for combining the first set of device map information and the second set of device map information based on the at least one common device.

26. The first device of claim 25, wherein the means for combining the first set of device map information and the second set of device map information is further based on one or more common objects.

27. The first device of claim 25, wherein the first set of device map information comprises a first set of devices and each device in the first set of devices comprises one or more device characteristics and wherein the second set of device map information comprises a second set of devices and each device in the second set of devices comprises one or more device characteristics and wherein the means for determining whether the first set of device map information and the second set of device map information contain the at least one common device comprises:
means for determining whether a device is a common device based on a comparison of one or more characteristics corresponding to a device in the first set of devices and one or more characteristics corresponding to a device in the second set of devices.

28. A non-transitory computer-readable medium for generating a real-world traffic model comprising processor-executable program code configured to cause a processor of a first device to:
obtain a first set of device map information associated with one or more devices that are in proximity with the first device;
obtain a second set of device map information associated with one or more devices that are in proximity with a second device;
determine whether the first set of device map information and the second set of device map information contain at least one common device; and
in response to the determination that the first set of device map information and the second set of device map information contain the at least one common device, generate a real-world traffic model of devices based on the first set of device map information and the second set of device map information.

29. The non-transitory computer-readable medium of claim 28, wherein the first set and second set of device map information comprises one or more position information for each device and one or more device identification information for each device.

30. The non-transitory computer-readable medium of claim 29, wherein the one or more position information comprises: range, orientation, range angle, RF characteristics, absolute coordinates, velocity, position uncertainty, confidence level or any combination thereof.
